(19) United States
(12) Patent Application Publication
(10) Pub. No.: US 2012/0180095 A1
(43) Pub. Date: Jul. 12, 2012

(54) TRANSMITTER AND TRANSMISSION METHOD

(76) Inventors: Mayuko TANAKA, Yokohama (JP); Takahiko Nozoe, Yokohama (JP); Hiroo Okamoto, Yokohama (JP)

(21) Appl. No.: 13/311,253

(22) Filed: Dec. 5, 2011

(30) Foreign Application Priority Data
Jan. 12, 2011 (JP) 2011-003542

(51) Int. Cl. H04N 21/23

(52) U.S. Cl. 725/88

(57) ABSTRACT

Ease of use for the user is provided when a client copies or moves a content in a server by considering copying or moving of management information associated with the content. The present invention is so configured to show that it has a chapter information sharing means as extension information of equipment information of the server, and to allow a client to obtain chapter information from the server when the content is copied or moved.

### CLAIM OF PRIORITY

The present application claims priority from Japanese patent application serial no. JP 2011-003542, filed on Jan. 12, 2011, the content of which is hereby incorporated by reference into this application.

### BACKGROUND OF THE INVENTION

(1) Field of the Invention

The present invention relates to a device for transmitting a content.

(2) Description of the Related Art

In connection with the above-mentioned technical field, Japanese Unexamined Patent Publication No. 2006-155828 describes a playback system with an object “to provide a playback system which allows appropriate reference to a content contained in a plurality of audio-visual equipment and the like connected to a network by users and easy viewing of such a content on a packet-by-packet basis”, and as a solution, the system includes “a communication unit which communicates with a device on a network, a playback unit which decodes and plays a content on a packet-by-packet basis, which obtains by controlling the communication unit management information (VR_MANGR.IFO) of the content stored in a device on a network, indicates the details of the content based on the management information, obtains the content on the device on a packet-by-packet basis via the communication unit depending on the playback direction in response to a playback direction from a user depending on this, a control unit which performs control to reproduce the packet of the obtained content in the playback unit”.

### SUMMARY OF THE INVENTION

In the Japanese Unexamined Patent Publication No. 2006-155828, however, when a content is copied or moved, copying or moving of management information associated with the content is not considered.

In order to solve the above problem, for example, the configuration described in the claims of the present invention is employed.

The above means allows the user, in viewing a copied or moved content, to playback the content from a position which is convenient for the user, improving ease of use for the user.

### BRIEF DESCRIPTION OF THE DRAWINGS

FIG. 1 is a block diagram which shows a constitutional example of a system.

FIG. 2 is a block diagram which shows a constitutional example of a transmitter 110.

FIG. 3 is a block diagram which shows a constitutional example of receivers 130, 140.

FIG. 4 is a drawing which shows an example of equipment information distributed by the transmitter 110.

FIG. 5A is a drawing which shows an example of the configuration of service description information.

FIG. 5B is a drawing which shows an example of the configuration of service description information.

FIG. 6 is a drawing which shows an example of content management information controlled by the transmitter 110.

FIG. 7 is a drawing which shows an example of a process sequence until the receivers 130, 140 searches for the transmitter 110, and obtains service information.

FIG. 8 is a drawing which shows an example of a process sequence when the receivers 130, 140 copy a content of the transmitter 110.

FIG. 9 is a drawing which shows an example of the configuration of content attachment information.

FIG. 10 is a drawing which shows an example the configuration of chapter information.

FIG. 11 is a drawing which shows an example of content information transmitted by the transmitter 110.

FIG. 12A is a drawing which shows an example of a “server search request” message.

FIG. 12B is a drawing which shows an example of a “response to server search request” message.

FIG. 13 is a drawing which shows an example of the flow of an update process of content management information of the transmitter 110.

FIG. 14 is a drawing which shows an example of the configuration of service description information.

FIG. 15A is a drawing which schematically represents chapter information indicating a content and scene breaks in the content.

FIG. 15B is a drawing which shows a specific example of chapter information.

FIG. 16A is a drawing which shows an example of an action “X_GetChapterList” request.

FIG. 16B is a drawing which shows an example of an action “X_GetChapterFlag” request.

FIG. 17 is a drawing which shows an example of the flow of a receiving process of a “X_GetChapterList” request.

FIG. 18A is a drawing which schematically represents chapter information indicating a content and scene breaks in the content.

FIG. 18B is a drawing which shows a specific example of chapter information.

FIG. 19 is a drawing which shows an example of the flow of a receiving process of a “X_GetChapterFlag” request.

FIG. 20 is a drawing which schematically represents chapter information indicating a content and scene breaks in the content.

FIG. 21 is a drawing which shows a specific example of content management information.

FIG. 22 is a drawing which shows a specific example of content management information.

FIG. 23A is a drawing which shows an example response of content list information.

FIG. 23B is a drawing which shows an example of the definitions for identifying a URL indicating a content and a chapter.

FIG. 24 is a block diagram which shows a constitutional example of content management information.

FIG. 25 is a drawing which shows an example of a process sequence of providing a content list and providing a content.

FIG. 26A is an example of a content transmission format.

FIG. 26B is an example of a content header.

### DETAILED DESCRIPTION OF THE EMBODIMENT

### Embodiment 1

Embodiment 1 according to the present invention will be described.

This Embodiment relates to the operations of the transmitter and the receiver when a content recorded in the transmitter which manages chapter information indicating a scene break in the content is copied to a receiver on a network. It should be noted that the present invention is not limited to the form shown in this Embodiment.

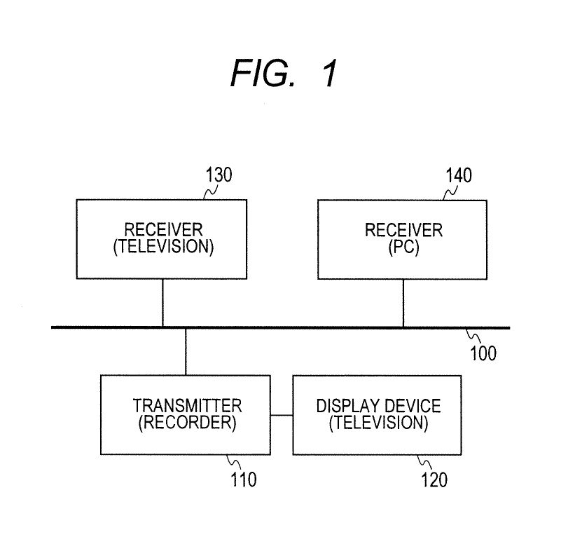

FIG. 1 shows a constitutional example of a home network system including a transmitter and a receiver according to this Embodiment.

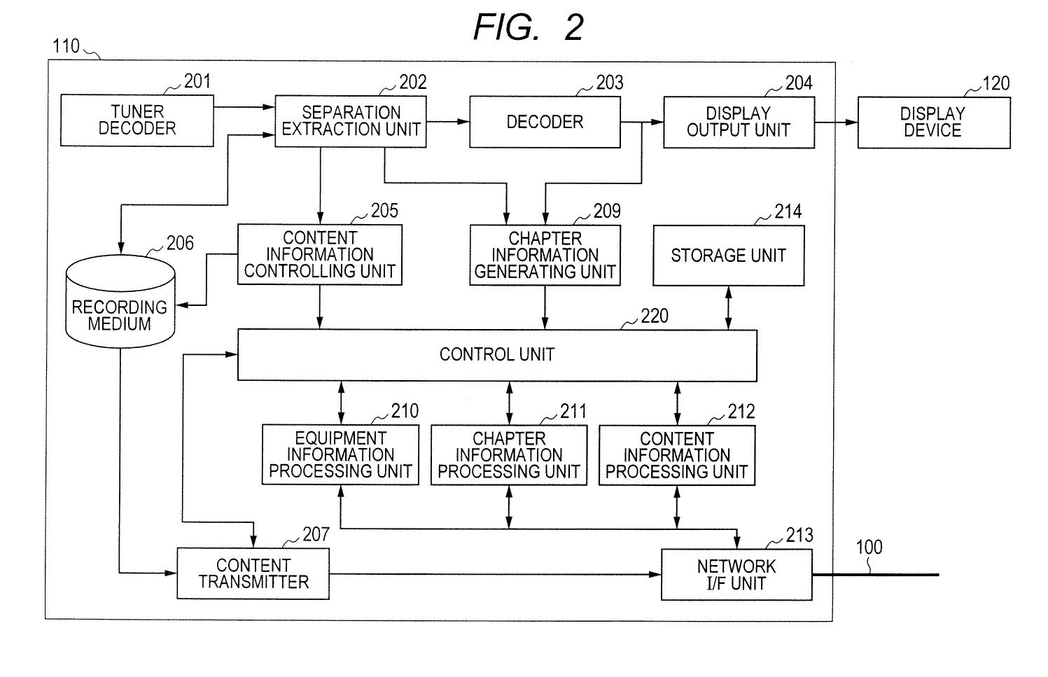

A numeral 110 is a transmitter (server) which transmits video, audio and image contents to the receiver (receivers 130 and 140 described later) on a home network 100, and is a device which stores and manages chapter information indicating a scene break in a content according to this Embodiment. Examples of such a transmitter include recorders and television sets with recorders. For example, in the case of a recorder with no display device included, as shown in the figure, a display device 120 (television, etc.) is connected thereto to display a content played. An analog interface or a digital interface which outputs an analog or digital video data/audio data can be used to connect the transmitter 110 and display device 120. A detailed constitutional example of this transmitter 110 will be described later with reference to FIG. 2.

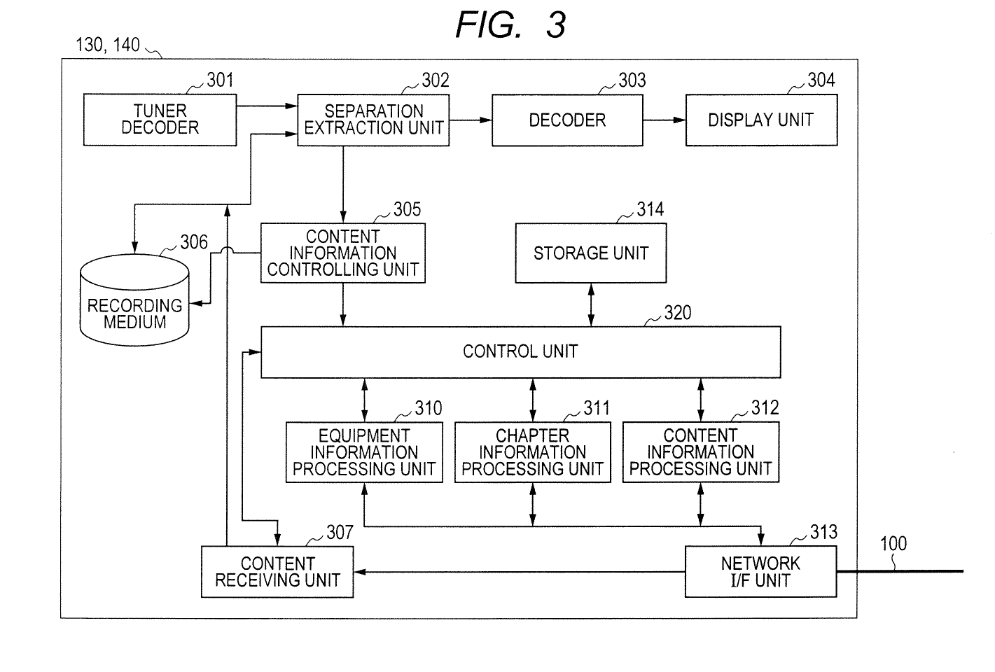

Numerals 130 and 140 are receivers (clients) which receive video, audio and image contents from the transmitter 110 on the home network 100 and play or record them. Examples of such receivers include television sets and PCs. Although not shown in the figures, for example in the case of a STB (Set Top Box) with no display device included, a display device (a television set, etc.) is connected to display a played content as in the transmitter 110. A detailed constitutional example of these receivers 130, 140 will be described later with reference to FIG. 3. Moreover, although not described in this Embodiment, a device including the functions of both these transmitter and receiver is also possible. Such a device may have any functions as long as they realize the functions (configuration and control method) of the transmitter and receiver described below, in which division and integration of the functions are optional. Such a home network 100 is built by, for example, a well-known IP (Internet Protocol) network.

A detailed constitutional example of the transmitter 110 according to the present invention will be now described with reference to FIG. 2.

The transmitter 110 is a device which receives digital broadcasting, records and plays a content, and transmits the content to the receiver on the home network 110. Such recording of a content may be applied to that by receiving and downloading of IP broadcasting through the network. Herein, the functions of the components of the transmitter 110 will be described below, taking as an example the case where digital broadcasting signals encoded by the MPEG (Moving Picture Experts Group) method as an image compression technique and multiplexed by the MPEG2-TS method are handled.

The transmitter 110 includes a tuner decoding unit 201, separation extraction unit 202, decoder 203, display output unit 204, content information controlling unit 205, recording medium 206, content transmitter 207, chapter information generating unit 209, equipment information processing unit 210, chapter information processing unit 211, content information processing unit 212, control unit 220, network I/F unit 213 and storage unit 214. 120 is a display device described in FIG. 1. The separation extraction unit 202, decoder 203, content information controlling unit 205, content transmitter 207, chapter information generating unit 209, equipment information processing unit 210, chapter information processing unit 211 and content information processing unit 212 are not necessarily constituted by hardware devices, but may be suitably realized using software programs. In this case, the programs are expanded in a primary memory (not shown), and are executed by the control unit 220.

The tuner decoding unit 201 receives digital broadcasting signals transmitted through broadcasting transmission networks such as wireless (satellite, terrestrial) and cable networks. The frequency of a channel specified by the direction of the user with a remote controller and the like is subjected to tuning and detecting processes. Moreover, MPEG2-TS (transport stream) which has been subjected to digital decoding and error correction processes is output to the separation extraction unit 202.

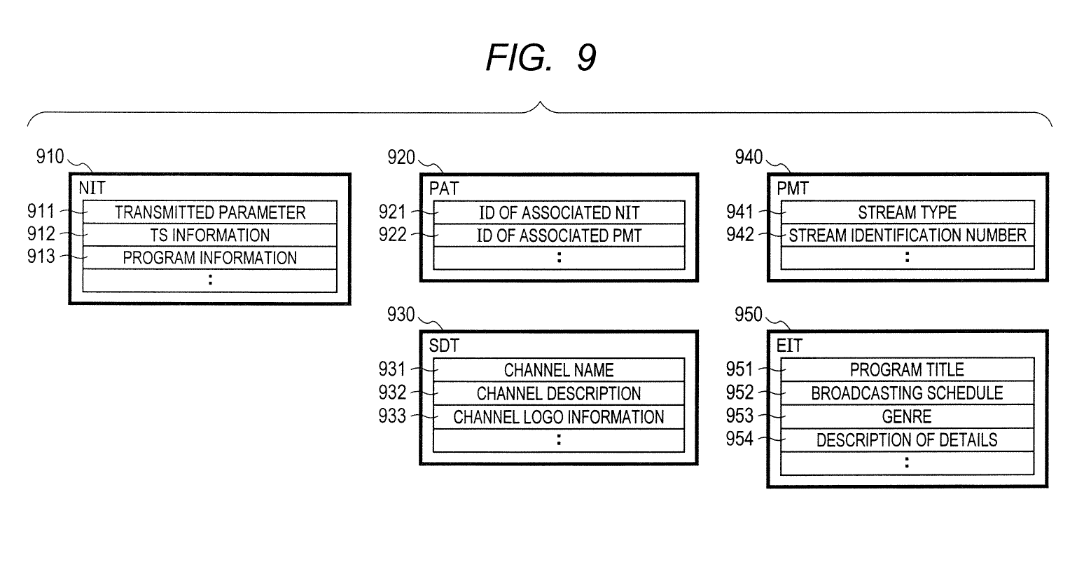

The separation extraction unit 202 separates and extracts a transport packet of a channel (program) specified by the direction of the user with a remote controller and the like from the input MPEG2-TS. When the received digital broadcasting signals are viewed, visual and audio PES (Packetized Elementary Stream) or ES (Elementary Stream) is separated and extracted from the separated and extracted transport packet, and is output to the decoder 203. When the digital broadcasting signals are recorded, they are recorded in the recording medium 206 with information of a time stamp added to the separated and extracted transport packet. At this time, the information is recorded by performing an appropriate encrypting process via an encryption unit (not shown). Furthermore, content information such as title, genre and format information of the channel (program) recorded in the recording medium 206 is detected from the separated and extracted transport packet, and this information is output to the content information controlling unit 205. This information indicating the title, genre, broadcasting schedule, etc., for example, is contained in PSI (Program Specific Information) or SL (Service information) information of MPEG-TS (the outline of PSI, SI information will be described later with reference to FIG. 9). When the content recorded in the recording medium 206 is played, the content encrypted via an encryption decoder (not shown) is decoded. The visual and audio PES or ES is separated and extracted from the decoded transport packet, and is output to the decoder 203 according to the time stamp added when recorded.

The decoder 203 decodes the input visual/audio PES or ES into a visual/audio signal, and outputs the signal to the display output unit 204.

The display output unit 204 outputs the decoded visual/audio signal to the display device 120 via a digital-and-analog, or digital-or-analog interface. At this time, operation screen images such as menus to be presented to the user and content list generated in a rendering unit (not shown) are synthesized with the decoded visual signals and output.

The content information controlling unit 205 produces management information (illustrated in FIG. 6 below in detail) of the content based on the content information input from the separation extraction unit 202, and stores the information in the storage unit 214 (or recording medium 206). The content information controlling unit 205 also performs control so that a transport packet output to the recording medium 206 from the separation extraction unit 202 is recorded based on the above management information. Meanwhile, when the content recorded in the recording medium 206 is transmitted to the receivers 130, 140 on the home network 100, first, the transport packet of the content recorded in the recording medium 206 directed by the operation of the user with a remote controller and the like is successively read, and this transport packet is output to the content transmitter 207. At this time, the encrypted content is decoded via an encryption decoder (not shown), and an encrypting process for outputting the content to the home network is performed.

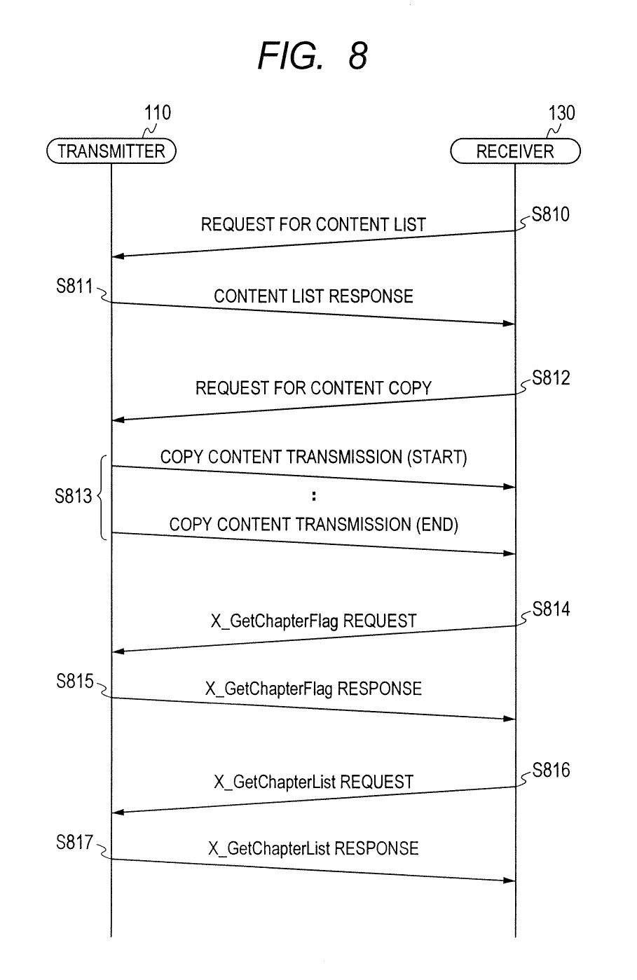

The content transmitter 207 outputs the transport packet of the content processed by the encrypting process for outputting the content to the home network to the network I/F unit 213. Moreover, the content transmitter 207 receives a content transmission control request transmitted from the receivers 130, 140 via the network I/F 208. The content transmission control request is a request to copy a content, a request to stop transmission or the like. The content transmitter 207 which has received the copy request reads the transport packet of the specified content, and outputs to the network I/F unit 213. The content transmission sequence when the copy request is received will be illustrated in FIG. 8 below. Moreover, association between the chapter information generated by the chapter information generating unit 209 and the content is managed. The content transmission unit also performs control in such a manner that when the associated content is divided, the chapter information is also divided and the association information is updated, while when the associated content is deleted, the chapter information is also deleted.

The chapter information generating unit 209 generates chapter information indicating a scene break in a content in the recording medium 206. The chapter information is generated by, for example, the user where he/she views a played content and directs to specify a scene break position with a remote controller or the like. The methods for automatically generating the chapter information include determining a scene break when a scene change is detected from visual signals, and a silent period of audio signals is detected, and detecting character information from subtitle information added to digital broadcasting and telops in programs, and determining a scene break when the detected character information matches predetermined characters specified in advance, or by other methods.

The equipment information processing unit 210 retains information disclosed to a different device on the network by the transmitter 110 on the storage unit 214, and transmits the information of the transmitter 110 itself in response to a request from a different device on the network such as the receivers 130, 140 and service information provided by the transmitter 110.

The chapter information processing unit 211 transmits chapter information via the network I/F unit 213.

The content information processing unit 212 transmits content information managed by the content information controlling unit via the network I/F unit 213.

The network I/F unit 213 outputs the transport packet input from the content transmitter 207 to the receivers 130, 140 via the home network 100 while converting the transport packet into a format in conformity with the transmission standard and controlling the flow of the same. The network I/F unit 213 is also used in transmitting information such as chapter information, equipment information, service description information described later to the receivers 130, 140 on the home network 100 and the like or receiving such information.

The control unit 220 generally controls the operations of the components in the transmitter 110.

A detailed constitutional example of the receivers 130, 140 will be now described with reference to FIG. 3. The receiver 130 will be described as an example herein. The receiver 130 is a device which receives a content from the transmitter 110 on the digital broadcasting and home network 100, and records or plays the content. The receiver 130 includes a tuner decoding unit 301, a separation extraction unit 302, a decoder 303, a display output unit 304, a content information controlling unit 305, a recording medium 306, content receiving unit 307, equipment information processing unit 310, a chapter information processing unit 311, a content information processing unit 312, a control unit 320, and a network I/F unit 313. The separation extraction unit 302, decoder 303, content information controlling unit 305, recording medium 306, content receiving unit 307, equipment information processing unit 310, chapter information processing unit 311, and content information processing unit 312 are not necessarily configured by hardware devices, but may be implemented by software programs. In this case, the programs are expanded in the primary memory (not shown), and are executed by the control unit 320.

When digital broadcasting is received and played, the tuner decoding unit 301 receives digital broadcasting signals transmitted through a broadcasting transmission network such as wireless (satellite, terrestrial) and cable networks. The tuner decoding unit 301 performs tuning and detecting processes on the frequency of the channel specified by the direction of the user with a remote controller and the like. The tuner decoding unit 301 also outputs the output to the separation extraction unit 302 via a selector MPEG2-TS (transport stream) which has been subjected to digital decoding and error correction processes (not shown).

The separation extraction unit 302 separates and extracts the transport packet of the channel (program) specified by the direction of the user with a remote controller and the like from the input MPEG2-TS. Visual and audio PES (Packetized Elementary Stream) or ES (Elementary Stream) is further separated and extracted from the separated and extracted from the transport packet, which is output to the decoder 312.

In contrast, when the content received from the transmitter 110 on the home network 100 is played or copied, first, the transport packet of the content transmitted by the transmitter 110 as a result of the direction by the operation of the user using a remote controller or the like is successively received via the network I/F unit 308. The network I/F unit 308 receives the transport packet which is to be output to the content receiving unit 303 via the home network 100 from the transmitter 110 while converting the transport packet from the format in conformity with the transmission standard and controlling the flow. The network I/F unit 308 is also used in transmitting information such as content information, chapter information, equipment information and service description information described later to the transmitter 110 on the home network 100 and the like and/or receiving such information.

When the content received from the transmitter 110 is played, the transport packet received via the network I/F unit 313 is output to the content receiving unit 303, and the output is further output to the separation extraction unit 302 via the selector (not shown). At this time, the content encrypted when transmitted via the network I/F is decoded by a network transmission decoder (not shown). When the content is copied, it is recorded in the recording medium 306.

The content receiving unit 303 also transmits a start position of the transmitted content based on the chapter skip, faster playback, start and end of pause and other commands given by the user using a remote controller and the like to the transmitter 110 via the network I/F unit 311, a request to start transmission, and a request to stop transmission by adding length as a parameter.

The separation extraction unit 302 separates and extracts visual and audio PES (Packetized Elementary Stream) or ES (Elementary Stream) from the transport packet input from the content receiving unit 307 to output to the decoder 303.

The decoder 303 extracts and decodes the visual/audio PES or ES, and the decoded visual/audio PES or ES is output to the display unit 304.

The display unit 304 indicates decoded visual/audio. At this time, operation screen images such as menus, content lists and chapters presented to the user generated in a rendering unit (not shown) are synthesized with the decoded image and indicated.

The content information controlling unit 305 is a means for managing the association of the content recorded in the recording medium 306 with content information and chapter information. The content information controlling unit stores content information and chapter information in the recording medium 306 or storage unit 314, and suitably reads and uses the same. When a content is obtained and copied from the transmitter 110 via the network, the content information controlling unit generates content information in the recording medium which is information for managing the content in the recording medium from the content information obtained from the transmitter 110, and manages the association of the chapter information with the content obtained from the transmitter 110.

The equipment information processing unit 310 is a means for retaining equipment information disclosed to a different device on the network on the storage unit 314 according to the control of the control unit 320, and obtaining and processing such information. The chapter information processing unit 311 receives and processes the chapter information of the content retained by the transmitter 110.

The content information processing unit 312 is a means for receiving and processing the content information of the content retained by the transmitter 110.

The control unit 320 generally controls the operations the components in the transmitter 130.

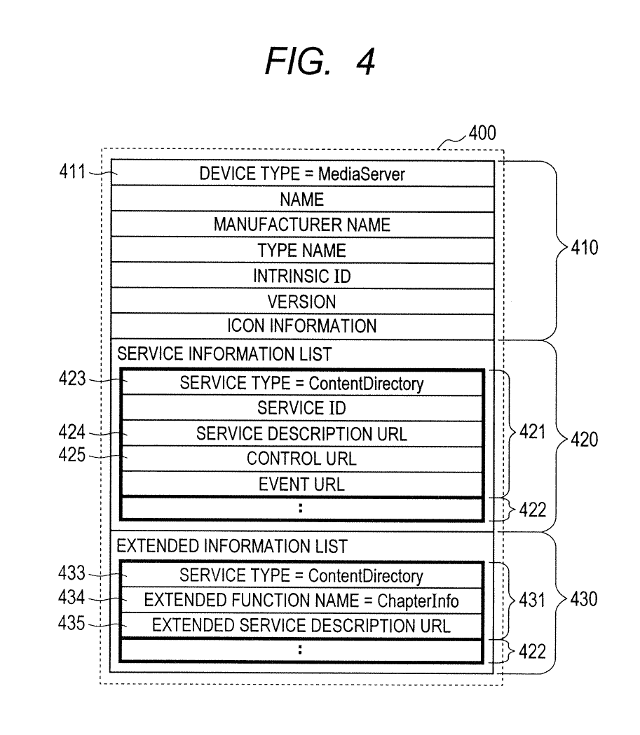

An example of the equipment information which is transmitted (responded) by the transmitter 110 in response to a request from the receivers 130, 140 will be described with reference to FIG. 4. Information which indicates that the transmitter 110 has a function of transmitting chapter information is added to this equipment information.

The equipment information 400 includes device information 410 descriptive of the information of the device itself, a service information list 420 descriptive of the information of services provided by the device, and an extension information list 430. The service information list 420 contains service information (421, 422) descriptive of at least one service. The extension information list 430 is added when the service described by the service information list 420 has an extensive function. It should be noted that the configuration of this equipment information 400 is not unique to the transmitter (server). It is indicated that it is a transmitter (server) by the value of device type of the device information 410.

The device information 410 describes the information of the device itself. As shown in FIG. 4, the device information includes device type 411, name, manufacturer's name, model name, unique ID, version, icon information and the like. The device type 411 describes the types of devices such as servers, printers and gateways. In the case of the transmitter 110 of this Embodiment, the device type 411 is described as “MediaServer” to indicate that it is a server.

The service information 421 (422) includes service type 423, service ID for identifying the service, service description URL 424, control URL, event URL and others for each service. The service type 423 describes the service type indicating a service such as “ContentDirectory”, i.e., a content list providing service, and “ConnectionManager”, i.e., a connection manager which provides the format of the protocol of streaming, among others. The service description URL 424 describes a URL indicating the access destination to obtain the service description information, which is detailed information for utilizing the service described in the service type 423. The control URL is a URL which indicates the access destination when the service described in the service description URL 424 is controlled, and the event URL describes a URL which indicates the access destination when an event is notified. In this Embodiment, the transmitter 110 provides a content list of contents distributed with the device type 411 being “MediaServer”. Therefore, the service type 423 of the service information 421 is described as “ContentDirectory”.

The extension information list 430 is added when the service described in the service information list 420 has at least one function extension. When only one service has a function extension, the extension information list 430 includes one piece of extension information. When a plurality of services has function extensions, as many function extensions as the services are added, as extension information 431, 432. The extension information 431 (432) includes service type 433, extended function name 434 and extended service description URL 435. 433 indicates the service type of a service whose function is extended. This service type 433 corresponds to the service type 423 in the service information list 420, and associates this extension information with the extension information of a service. In this Embodiment, the function of transmitting chapter information is an extension of “ContentDirectory”. Therefore, the service type 433 is described as “ContentDirectory”. The extended function name 434 describes the name indicating a function which extends the service described in the service type 433. In this Example, it is described as “Chapterlnfo” as an Embodiment of the function name indicating that a function of transmitting chapter information is provided. The extended function service description URL 435 describes the URL indicating the access destination to obtain service description information which is detailed information for utilizing an extended function of a service.

Such a configuration allows even a receiver which does not enable function extension to use services provided by the transmitter 110 by obtaining the equipment information 400 obtained from the transmitter 110, interpreting the device information 410 and service information list 420, and obtaining detailed information for utilizing a service from the place where the information is stored indicated by the service description URL 424. A receiver which enables function extension can further obtain the extension information 430, interpret the extension information 431 (432), and obtain detailed information for using extended functions of services from the place where the information is stored indicated by the extended function service description URL 435. In the case of this Embodiment, a function of transmitting chapter information “ChapterInfo” which is an extended function of the “ContentDirectory” service can be used.

The information indicating that the service has function extension is optionally described in the device information 410 and service information list 420. In that case, the information indicating the service has the function of transmitting chapter information is optionally described to indicate that it is extension information in the device information 410 and service information list 420 respectively, or at the end.

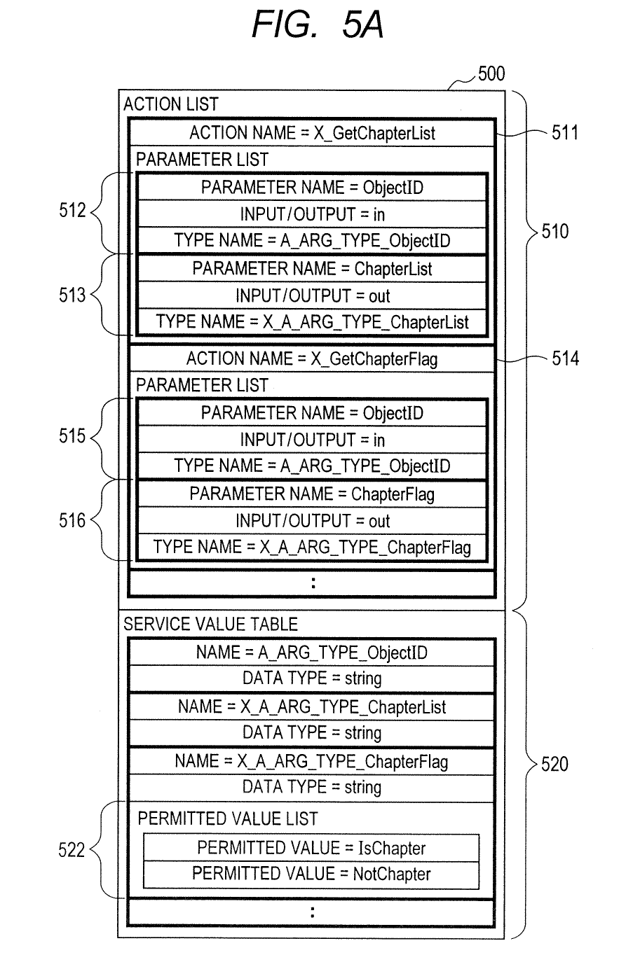

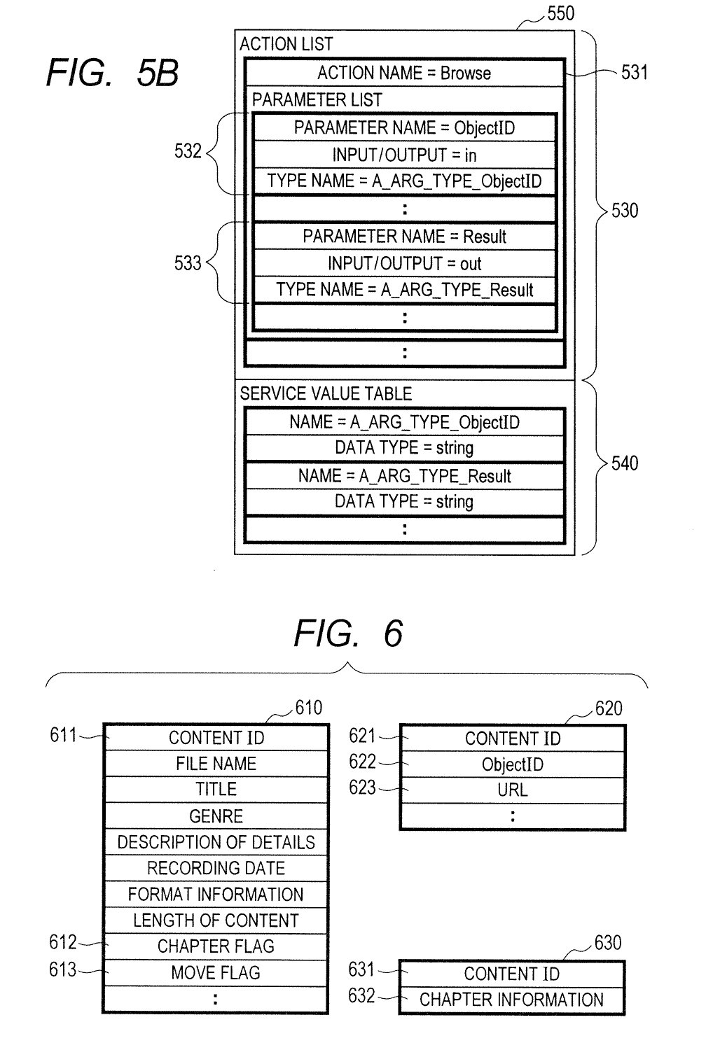

Subsequently, the service description URL 424, and the service description information obtained from the extended function service description URL 435 will be described with reference to FIGS. 5A and 5B. The service description information of normal functions provided by the service can be obtained from the service description URL 424, and the service description information of extended functions can be obtained from the extended function service description URL 435. That is, the service description information is prepared for each service. Furthermore, when the service has an extended function, service description (hereinafter referred to as extended service description information) is prepared for the extended function. FIG. 5A shows an example of the configuration of the extended service description information which can be obtained from the extended function service description URL 435, while FIG. 5B shows an example of the configuration of service description information which can be obtained from the service description URL 424. Both FIGS. 5A and 5B have the same configuration. The service description information is transmitted by the transmitter 110 in response to a request from the receivers 130, 140 by access to the service description URL 424 or the extended function service description URL 435, and is retained in the equipment information processing unit 210 described in FIG. 2. As shown in FIGS. 5A and 5B, the service description information 500 (550) includes an action list 510 (530) indicating one or more methods of action (control) for the service, a service value table 520 (540) describing the types of the input/output values of actions described in the action list 510 (530). The action list 510 (530) describes the action names of the actions and a parameter list used in the actions. The parameter list describes the parameter name, the directions of input and output, and the type name for each parameter.

In FIG. 5A, a numeral 500 is an example of the extended service description information relating to a function of transmitting chapter information “ChapterInfo” which is an extended function of the “ContentDirectory” service according to the present invention, which shows an example of definitions of actions relating to obtaining and setting the chapter information. The action indicated by the action name “X_GetChapterList” 511 is the transmission of a chapter information 632 (described later) by the transmitter 110 in response to a request to obtain the chapter information from the receivers 130, 140. More specifically, the receivers 130, 140 specify the value of the parameter name “ObjectID” indicated by the parameter 512 and requests the transmitter 110 to get the chapter information. The transmitter 110 which has received this get request then sets the chapter information of the content corresponding to the value set in the parameter name “object ID” of the parameter 512 in the parameter name “ChapterList” of the parameter 513 and returns the information. It should be noted that the parameter name “object ID” indicated herein is the ID which uniquely determines the content transmitted by the transmitter 110 (described later in detail). That is, the action name “X_GetChapterList” 511 defines the action of responding the chapter information for the designated content. The ID which uniquely determines the content is provided by an action “Browse” (described later) which provides the content list provided as a normal function by the “ContentDirectory” service.

The action indicated by an action name “X_GetChapterFlag” 514 indicates whether or not the transmitter 110 can provide the chapter information of the specified content in response to a get request from the receivers 130, 140. More specifically, the content for which whether or the receivers 130, 140 can provide the chapter information 612 (described later) by the parameter name “object ID” of the parameter 515 is confirmed is specified. The transmitter 110 which has received this get request sets the information which indicates whether the chapter information can be provided in the parameter name “ChapterFlag” of the parameter 516 and returns the information. That is, the action name “X_GetChapterFlag” 514 defines the action of responding the availability of the chapter information for the specified content.

The service value table 520 is a table for describing the types of the input and output parameters of the action, and describes the data types (character string, unsigned 4-byte integer type, etc.) of the type names described in the parameter list of the action list 510 for each type. 520 in FIG. 5A shows the case where the data types of the type names “A_ARG_TYPE_object ID”, “X_A_ARG_TYPE_ChapterList”, and “X_A_ARG_TYPE_ChapterFlag” described in the parameters 512, 513, 515, 516 on the action list 500 are described in the service value table 520. Herein, both types are described as the data type of the character string “string”. That is, the parameters “ObjectID”, “ChapterList”, and “ChapterFlag” are represented by character strings. A permitted value list 522 is a description of the case where the described type name is defined to have only the specified value. It is indicated in the case of this Embodiment that the type name “X_A_ARG_TYPE_ChapterFlag” has the values “IsChapter” and “NotChapter” only. When the chapter information is available, the value “IsChapter” is returned, while when not available, the value “NotChapter” is returned.

As indicated above, configuring the receivers 130, 140 to refer to the equipment information 400 allows the transmitter 110 to provide the “ContentDirectory” service, and recognize that the function of transmitting chapter information “ChapterInfo” is provided as an extended function of the “ContentDirectory” service. Furthermore, it is possible to obtain a means for obtaining and setting the chapter information by referring to the service description information 500. It should be noted that the names mentioned herein are used as examples, and are not limited to those named herein.

The outline of PSI, SI information will be now described with reference to FIG. 9. The PSI, SI information is content attachment information contained in MPEG-TS. The separation extraction unit 202 of the transmitter 110 analyzes the content attachment information (PSI, SI information), extracts the title, genre, broadcasting schedule and other information corresponding to the content (program) recorded in the recording medium 206, and outputs the information to the content information controlling unit 205. The content information controlling unit 205 generates content information in the recording medium (described later) for each content from the information obtained from the content information controlling unit 205, and assigns a content ID which uniquely determines the content in the recording medium to the content information to manage the same.

In FIG. 9, an NIT (Network Information Table) 910 stores a transmitted parameter 911 which stores frequency information and other information mainly for receiving a desired program from airwaves, TS (transport stream) information 912 such as the transmission type of the transport stream corresponding to the transmitted parameter, and program information 913 including information of the channel number and the like corresponding to the transmitted parameter, among others. The PAT (Program Association Table) 920 stores an ID 921 for the NIT 910 contained in the transport stream and the ID 922 for a PMT 940 described later for each channel (program). The SDT (Service Description Table) 930 stores a channel name 931 of the channel contained in the transport stream, channel description 932, channel logo information 933 such as link information to logo data of the channel for each channel. The PMT (Program Map Table) 940 stores stream type 941 (which identifies digital television service and digital radio audio service), a stream identification number 942 for identifying actual data storing the stream and the like for each stream. An EIT (Event Information Table) 950 stores a program title 951, a broadcasting schedule 952 indicating the starting and end time of the program, a genre 953 for identifying the genre of the programs, detailed description 954 indicating an explanation of the programs and the like for each channel. These tables store IDs which uniquely determine the corresponding transport stream, channel and program (not shown) respectively, and are associated with each other.

The content management information, content information in the recording medium, chapter management information, and distributed content information managed by the content information controlling unit 205 of the transmitter 110 will be now described with reference to FIG. 6.

In FIG. 6, the content information in the recording medium 610 is a management table which manages the information of the content recorded in the recording medium; a network distributed content information 620 is a table which manages the information for network distribution of the content; and chapter management information 630 is a table which manages chapter information indicating a scene break in the content. In the figures, examples of data configuration of the tables are shown. Such management information is retained in the storage unit 214 (or recording medium 206).

The content IDs 611, 621, 631 are IDs which uniquely determine the contents in the recording medium, and are assigned to the content information controlling unit 205 when the content is recorded. This content ID mutually links the content information in the recording medium 610, network distributed content information 620, and chapter management information 630 of each content.

The content information in the recording medium 610 includes a content ID 611, chapter flag 612, file name, title, genre, detailed description, recording date and time, format information, content length and other information. The chapter flag 612 is information indicating if the chapter information of this content is present (for example, the value “1” is set when chapter information is present, while the value “0” is set when there is none). The chapter flag 612 is updated by the content information controlling unit 205 when the chapter information is generated or deleted. The information attached to the content such as the title, genre and detailed description is information obtained from the PSI, SI information described in FIG. 9. The file name, recording date and time, format information and content length are calculated or generated when the content is recorded, and are recorded.

The network distributed content information 620 includes a content ID 621, object ID 622, URL 623 and the like. The object ID 622 is identification information (ID) of content open to the network. The object ID 622 is a value specified in the parameter “ObjectID” 512 and the like for specifying the content of the action “X_GetChapterList” 511 for providing the chapter information described in FIG. 5A. The URL 623 indicates the access destination of the receiver when a streaming of a content is received, copied or moved. The content ID 621 and object ID 622 may have the same value.

The chapter management information 630 includes the content ID 631 and the chapter information 632 indicating a scene break in the content. The chapter information 632 is generated in the chapter information generating unit 209 (FIG. 2), associated with the content ID 631, and retained in the chapter management information 630 for each content.

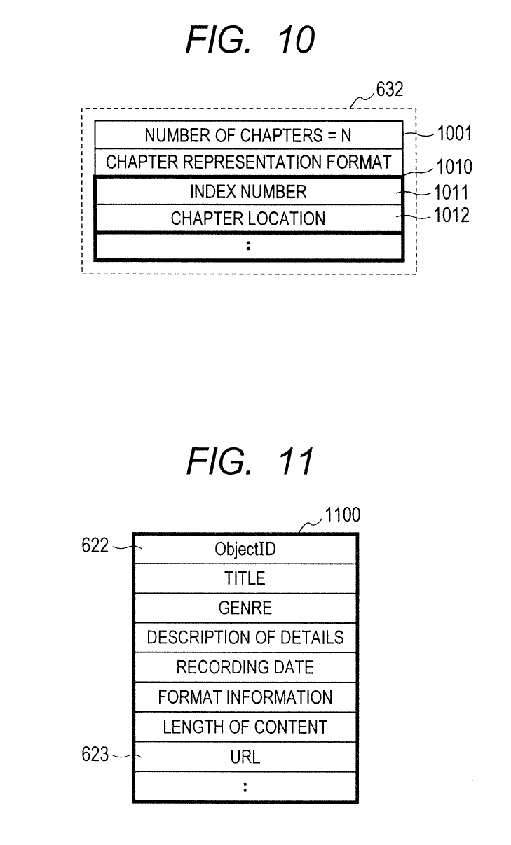

The configuration of the chapter information 632 will be now described with reference to FIG. 10. As shown in the figure, the chapter information 632 includes a number of chapters 1001, chapter representation format 1002, and as many chapter position information 1003 as the number of chapters. The number of chapters 1001 is the number of chapters (scene breaks) set with the content. The chapter representation format 1002 indicates the representation format of chapter positions. The chapter representation format 1002 is for indicating which representation format is used since the method of representing the chapter position may differ depending on the type and the recording format of the recording medium 206. Such representation formats include the position of the packet from the top of the content, the byte position from the top of the content, and the lapse of time from the top of the content. The chapter position information 1010 includes an index number 1011 of the chapter and a chapter position 1012.

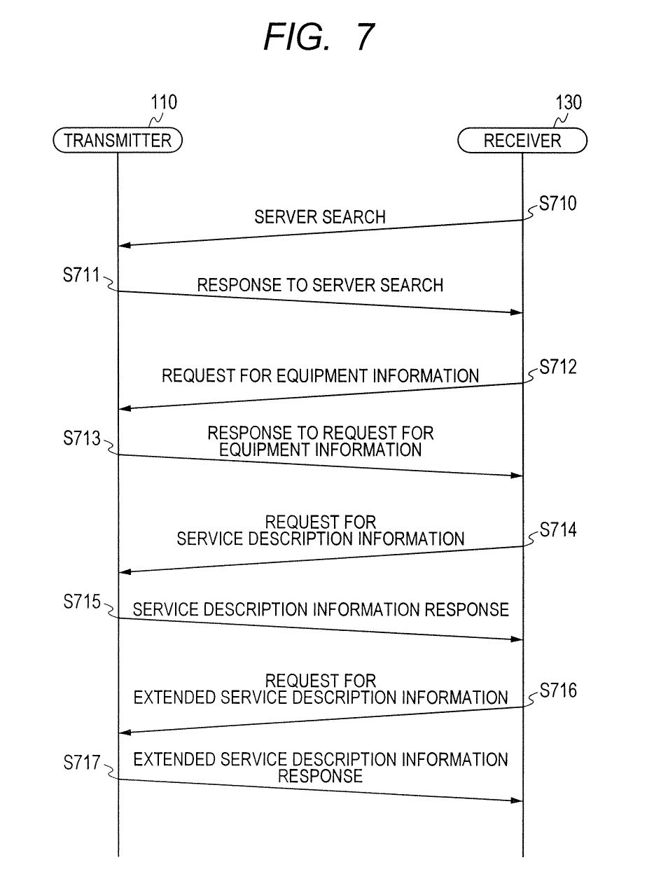

The operations of the transmitter and receiver when the content recorded in the transmitter 110 which manages the chapter information of the content is copied to the receivers 130 and 140 will be described with reference to the process sequence drawings in FIGS. 7 and 8.

FIG. 7 is a sequence from searching of the transmitter 110 by the receiver 130 to the obtainment of the service information provided by the transmitter 110. This procedure allows the receiver 130 to recognize that the transmitter 110 can have a function to provide the chapter information of the content as an extended function of the “ContentDirectory” service which provides the information of the content.

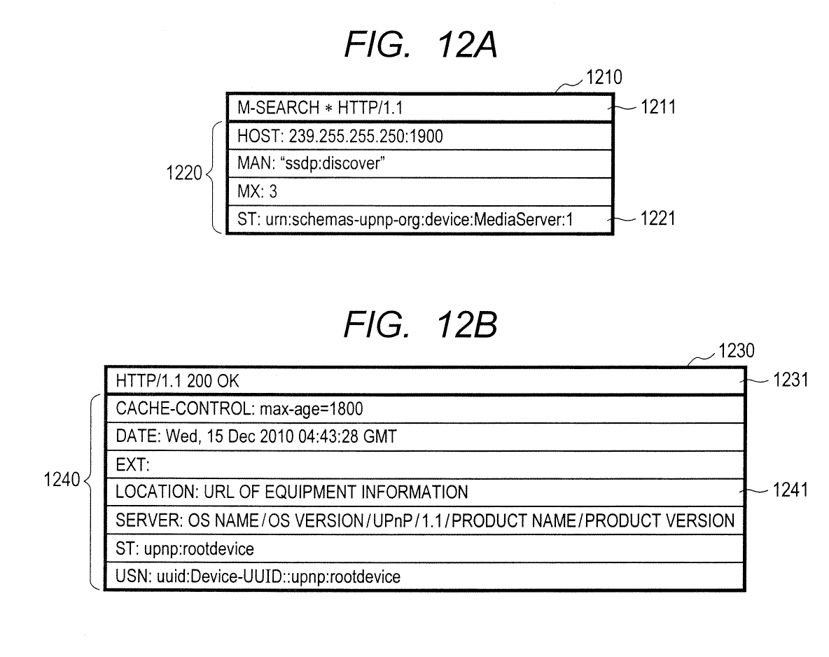

S710: The control unit 320 of the receiver 130 searches for a server device on the network by using an equipment information processing unit 310. That is, the equipment information processing unit 310 transmits a “server search request” message as a multicast transmission to the network 100 via the network I/F unit 313 according to the control of the control unit 320, and searches for a device having a server function which provides the content. More specifically, the device type, service type or the like is specified in a “to be searched” field of the message. In the case of this Embodiment, the device type “MediaServer” is specified in the “to be searched” field. FIG. 12A is an example of the “server search request” message in the case where searching by UPnP (registered trademark) is used. 1210 is a request message of HTTP (Hyper Text Transfer Protocol); 1211 is a request line; and 1220 is a header. A “ST” field 1221 is the “to be searched” field for specifying an object to be searched. The device type “MediaServer” is specified herein. A “HOST” field is the destination of the message, and indicates the address and port when a multicast message is transmitted in FIG. 12A. A “MAN” field indicates the extension of HTTP. The field shows that discovery by SSDP (Simple Service Discovery Protocol) is used as a protocol for UPnP (registered trademark) search. “MX” specifies the maximum latency (second) of response.

S711: When the transmitter 110 receives a “server search request” transmitted as a multicast transmission to the network 100, it analyzes and processes the message in the equipment information processing unit 210. The transmitter 100 refers to the equipment information 400 (FIG. 4) retained by the equipment information processing unit 210, and when the equipment information 400 meets the condition in the “to be searched” field, it transmits a “response to server search request” message to the receiver 130. In the case of this Embodiment, the device type of the receiver 130 is “MediaServer”, which meets the condition in the “to be searched” field. An equipment information URL which is the access destination to the equipment information of itself is set in a “location” field as the “response to server search request” message. This information allows the receiver 130 to obtain the equipment information of the transmitter 110. FIG. 12B shows an example of the “response to server search request” when the response to the UPnP (registered trademark) search request is used. 1230 is an HTTP response message; 1231 is a response line; and 1240 is a header. A “LOCATION” field 1241 is a “location” field descriptive of the equipment information URL.

The “response to server search request” message transmitted by the transmitter 110 is analyzed and processed in the equipment information processing unit 310 of the receiver 130, and the control unit 320 obtains the equipment information URL and the like obtained from the “LOCATION” field as target information of the transmitter 110.

S712: The control unit 320 of the receiver 130 which has obtained the equipment information URL of the transmitter 110 controls the equipment information processing unit 310, and has it transmit an “equipment information request” message to the equipment information URL using a request to get HTTP and the like.

S713: The control unit 220 of the transmitter 110 which has received the equipment information URL for the “equipment information request” message controls the equipment information processing unit 210, and has it transmit a “response to request for equipment information” message by using a response message to get HTTP. The equipment information processing unit 210 inserts the equipment information 400 retained by itself into the message body of the response to request for HTTP message in XML and like format, and generates a “response to a request for equipment information” message.

The control unit 320 of the receiver 130 which has received the response “response to equipment information” message from the transmitter 110 can obtain the information of the transmitter 110 device itself and service information from the equipment information 400 obtained, analyzed and processed in the equipment information processing unit 310 (previously described in FIG. 4). In the case of the equipment information 400 shown in FIG. 4, the equipment information processing unit 310 recognizes that the service provided by the transmitter 110 is “ContentDirectory” from the value of the service type 423 of the service information 421, and obtains the service description URL 424 which is the access destination of the service description “ContentDirectory”. When the receiver 130 further enables the description of the extension information list of the equipment information 400, the equipment information processing unit 310 also analyzes and processes the extension information list 430. The equipment information processing unit 310 recognizes that the “ContentDirectory” service has an extended function of “Chapterlnfo”, and obtains the extended service description URL 435 which is the access destination of the service description of the extended function.

The control unit 320 also obtains the control URL 425 which is the access destination when the transmitter 110 is controlled by the action provided by the service. The control URL 425 is the command destination of action commands both when a normal action of the “ContentDirectory” service is used and when the action of the extended function “ChapterInfo” is used.

S714: The control unit 320 of the receiver 130 which has obtained the service description URL of the transmitter 110 controls the equipment information processing unit 310, and has it transmit a “service description information request” message to the service description URL by using a HTTP get request and the like.

S715: The control unit 220 of the transmitter 110 which has received the “service description information request” message for the service description URL controls the equipment information processing unit 210, and has it transmit a “service description information response” message by using the HTTP response message and the like. The equipment information processing unit 210 inserts the service description information 500 retained by itself into the message body of the HTTP response message in a format such as XML, and generates a “response to a request for equipment information” message.

The control unit 320 of the receiver 130 which has received a response “service description response” message from the transmitter 110 can obtain the information (action name, parameter, data type, etc.) of the action to use the service provided by the transmitter 110 from equipment information 400 obtained, analyzed and processed in the equipment information processing unit 310 (previously described in FIG. 5).

S716: Subsequently, the receiver 130 transmits a request to get the “extended service description information request” message by using HTTP get request and the like to the extended service description URL 432 as in S714.

S717: The transmitter 110 which has received the “extended service description information request” message for the extended service description URL, as in S715, transmits a “service description information response” message by using the HTTP response message and the like.

As mentioned above, the receiver 130 can search the server (transmitting 110) on the network, and can obtain the service provided by the server and the detailed information of the service. Furthermore, by analyzing and processing the extension information list, the service description information of the extended function can be also obtained by the same procedure as that in the case where the service description information of the normal service is obtained. The receiver 130 in this Embodiment can recognize that the “ContentDirectory” service has an extended function of “Chapterlnfo”, and obtains the extended service description information to use the extended function.

Moreover, by providing the equipment information in the format as shown in FIG. 4, the transmitter 110 can provide the service description information of the extended function by a procedure similar to that in the case where the service description information of the normal service is obtained for the device which enables extension information list description. Furthermore, only the service description information of the normal service can be provided for a device which does not enable the extension information list description. Thus, the service description information suitable for the device which enables the extension information list description and the device which does not, respectively, can be provided.

Subsequently, a processing procedure performed when a content which has the chapter information is copied from the transmitter 110 using the information obtained by the service description obtained by the receiver 130 in the sequence in FIG. 7 will be described with reference to the sequence diagram in FIG. 8.

The receiver 130 issues an action command to the control URL 425 obtained in the sequence (S713) in FIG. 7, and uses the service provided by the transmitter 110.

S810: In order to determine a content to be copied, the receiver 130 first obtains content list information recorded in the transmitter 110. The content list information can be obtained using a Browse action of the “ContentDirectory” service. The control unit 320 of the receiver 130 controls the content information processing unit 312, and issues a “Browse request” message by using a HTTP POST request and the like to the control URL.

S811: The control unit 220 of the transmitter 110 which has received the “Browse request” message issued for the control URL controls the content information processing unit 212 to have it transmit a “Browse response” message by using the HTTP response message. The content information processing unit 212 refers to the content information in the recording medium 610 and network distributed content information 620 previously described in FIG. 6, and generates a content information for a browse response 1100 having the information as shown in FIG. 11 for each content. The transmitter 110 inserts the content information for Browse response into the message body of the HTTP response message in a format such as XML, and sends the information to the receivers 130, 140.

The control unit 320 of the receiver 130 which has received a response “Browse response” message from the transmitter 110 can obtain the content information of each content from the content information for Browse response 1100 obtained, analyzed and processed in the content information processing unit 312 (title, genre, URL, etc.). The control unit 320 prompts the user to select a content to copy by displaying information such as the title, recording date and time of the content on the display unit 304 and presenting the same to the user, or by other means. When a content to copy is selected, the control unit 320 gives the content information of the selected content to the content information controlling unit 305, generates the content information as shown in FIG. 6, and stores the information in the recording medium 306 or storage unit 314. In the information of the content information in the recording medium 610, the content ID 611 and the file name are generated by the content information controlling unit 305. The content ID 611 and file name are the information which uniquely specify the content and file name recorded in the recording medium of the receiver 130, respectively. For the value of the chapter flag 612, the value “NotChapter” which indicates that the content does not have the chapter information is set as an initial value. The content information for Browse response obtained in S811 is set for other information (title, genre, detailed description, recording date and time, format information, etc.). The receiver 130 does not have the network distributed content information 620, but manages received content information 650 having the same data configuration. The received content information 650 is the information which retains the object ID 622 which is the content identification information of the transmitter 110 and the URL 623 which is the URL information of the source of the content, and for reference of association with the content ID assigned by the content information controlling unit 305. The content information controlling unit 305 retains the received content information 650 until a series of processes of copying the content is completed.

S812: The receiver 130 transmits a “content copy request” to the URL obtained from the content information for browse response using the HTTP get request and the like.

S813: The control unit 220 of the transmitter 110 transmits the content specified by the URL via the content transmitter 207 to the receivers 130, 140. The receiver 130 receives the content in the content receiving unit 307, and records the content in the recording medium 306 by the file name assigned by the content information controlling unit 305 in S811. When the receiving of the content is complete, the content information controlling unit 305 updates and records the content information in the recording medium 610 with an actually received content length.

S814: When the receiving of the content is complete, the receiver 130 checks if this content has chapter information. The content list information can be obtained by an X_GetChapterFlag action of the extended function “ChapterInfo” of the “ContentDirectory” service. The control unit 320 of the receiver 130 controls the chapter information processing unit 311, and has it issue an “X_GetChapterFlag request” message to the control URL by using the HTTP POST request and the like. The object ID 622 retained in the received content information 650 in S811 is used as an input parameter object ID.

S815: The control unit 220 of the transmitter 110 which has received the “X_GetChapterFlag request” message issued for the control URL controls the chapter information processing unit 211, and has it transmit an “X_GetChapterFlag response” message by using the HTTP response message and the like. The chapter information processing unit 211 refers to the network distributed content information 620 with the input parameter object ID, and obtains the content ID corresponding to the object ID. The chapter information processing unit 211 then specifies the content information in the recording medium 610 of the content by the content ID, and returns the value of the chapter flag 612. The initial value of the chapter flag 612 set is “NotChapter”, indicating that it does not have chapter information, and “IsChapter” is set by the content information controlling unit 305 when the chapter information is generated. The “X_GetChapterFlag response” is transmitted to the receiver 130 by using the HTTP response message and the like.

The chapter information processing unit 311 of the receiver 130 which has received the “X_GetChapterFlag response” updates the value of the chapter flag 612 of the content information in the recording medium 610 with the value of the response. Herein, when the value of the ChapterFlag of the “X_GetChapterFlag response” is “NotChapter”, the content copy process sequence is terminated here.

S816: When the value of ChapterFlag is “IsChapter”, the chapter information processing unit 311 of the receiver 130 transmits a chapter information request to the transmitter 110. The chapter information can be obtained by using an X_GetChapterList action of the extended function “ChapterInfo” of the “ContentDirectory” service. The control unit 320 of the receiver 130 controls the chapter information processing unit 311, and has it issue an “X_GetChapterList request” message to the control URL by using a HTTP POST request and the like. The object ID 622 retained in the received content information 650 in S811 is used as the input parameter object ID.

S817: The control unit 220 of the transmitter 110 which has received the “X_GetChapterList request” message issued for the control URL controls the chapter information processing unit 211, and has it transmit the “X_GetChapterList response” message by using the HTTP response message and the like. The chapter information processing unit 211 refers to the distributed content information 620 by the input parameter object ID, and obtains the content ID corresponding to the object ID. The chapter information processing unit 211 then specifies the content information in the recording medium 610 of the content by the content ID, and refers to the value of the chapter flag 612. When the value of the chapter flag 612 is “NotChapter”, the chapter information of the specified content does not exist, and therefore an error code is returned as a response. When the value of the chapter flag 612 is “IsChapter”, the chapter information processing unit 211 specifies the chapter management information 630 of the content by the content ID, inserts the chapter information 632 in a format such as XML into the message body of the HTTP response message, and sends the information to the receivers 130, 140.

The chapter information processing unit 311 of the receiver 130 which has received the “X_GetChapterList response” does not update the chapter flag 612 when it receives an error code as a response. When the chapter information processing unit 311 receives the chapter information as a response, it updates the chapter flag 612 to “IsChapter”. The obtained chapter information is further stored in the chapter information 632 of the chapter management information 630. The content copy process sequence is completed by the above process. Thus, the control unit 320 of the receiver 130 has the received content information 650 of the content copied to the content information controlling unit 305 deleted.

As mentioned above, with the function to provide the content information which is an extension of the “ContentDirectory” service, the transmitter 110 can also provide the content and the chapter information of the content. When the receiver 130 copies a content in the server (the transmitter 110) on the network, it can also obtain the chapter information of the content. This enables chapter skip and skip playback according to the chapter information when the copied content is played, and improves the ease of use by the user.

### Embodiment 2

Embodiment 2 according to the present invention will be described.

This Embodiment relates to the operations of the transmitter and the receiver when a content recorded in a transmitter for managing chapter information indicating a scene break in a content is moved to a receiver on the network. It should be noted that the present invention is not limited to the form shown in this Embodiment.

In this Embodiment, the configurations of the transmitter 110 and the receiver 130 are the same as those in FIGS. 2 and 3 described in Embodiment 1. Moreover, the sequence from searching of the transmitter 110 by the receiver 130 to the obtainment of the service information provided by the transmitter 110 is also the same as that in FIG. 7 described in Embodiment 1. The process sequence in the case where the receiver 130 moves a content having chapter information from the transmitter 110 becomes a sequence in which S812 in FIG. 8 is replaced with a content move request, and S813 is replaced with a move content transmission.

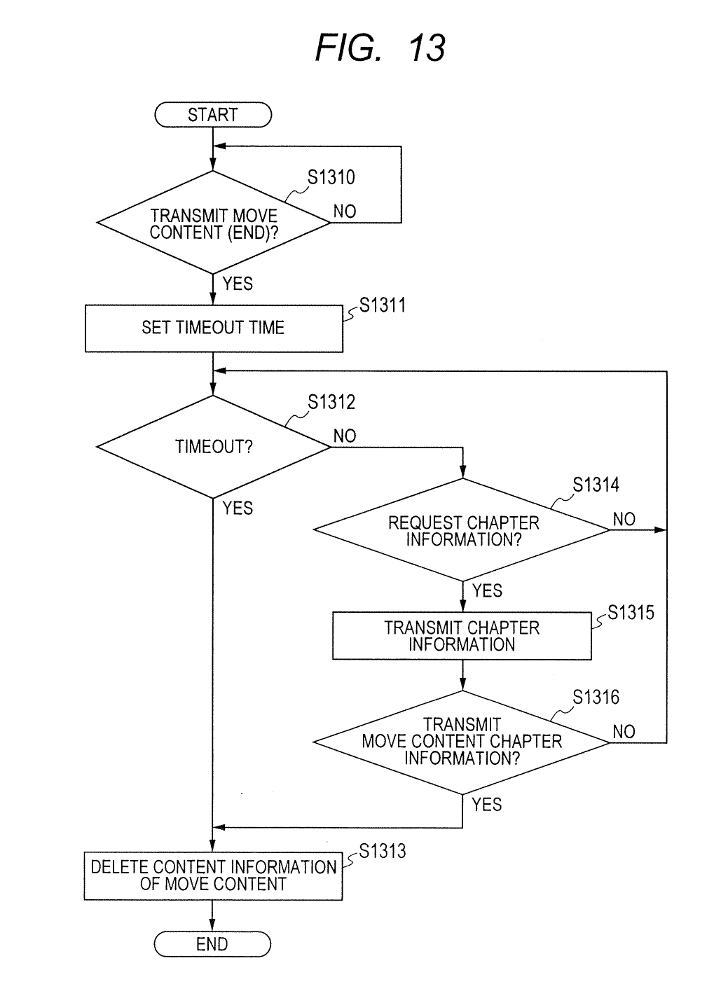

The difference between this Embodiment 2 and Embodiment 1 is the updating process of the content management information (FIG. 6) after the move content transmission (completion) in the transmitter 110. Explanation will be provided below with reference to the flowchart in FIG. 13.

S1310: The updating process of the content management information is started after the moved content is transmitted (completed) (S1311).

S1311: The control unit 220 sets timeout time until the updating process of the content management information. This timeout is set for each content. Moreover, the control unit 220 is set to, for example, a value “1”, which indicates that the content has been moved, as a MOVE flag 613 of the moved content.

S1312: The control unit 220 judges whether the timeout time has passed. If the timeout time has passed, the process proceeds to S1313. When the timeout time has not yet passed, the process proceeds to S1314.

S1313: The content information controlling unit 205 deletes the content management information by the direction of the control unit 220 of the move content. The move content is specified by the content ID. The content information controlling unit 205 deletes the content information in the recording medium 610, network distributed content information 620, and chapter management information 630, and terminates the updating process of the content management information.

S1314: The control unit 220 confirms whether or not the chapter information request “X_GetChapterList request” is received. When it has been received, the process proceeds to S1315. When it has not been received, the process proceeds to S1312.

S1315: The control unit 220 controls the chapter information processing unit 211, and has the chapter information of the content specified by the parameter object ID transmitted to the receivers 130, 140 as the “X_GetChapterList response” message by using the HTTP response message and the like.

S1316: The control unit 220 confirms whether or not the chapter information transmitted in S1315 is the chapter information of the move content. Whether it is the chapter information of the move content can be determined by whether the parameter object ID is the object ID of the move content. When it is the chapter information of the move content, the process proceeds to S1313. If not, the process proceeds to S1312.

As described above, the present invention according to the transmitter 110 sets the timeout time until the content information is deleted when the content is moved. Accordingly, when the content information request is received after the content is moved and a period of time has passed, the chapter information can be provided within the timeout time. Therefore, the content information can be provided to even a receiver which moves a plurality of contents and then receives the content information, leading to an increased degree of freedom of the process sequence on the receiver side. Although not described herein, such a configuration that allows setting of the time until the moved content information is deleted on the receiver side is also possible.

Moreover, since the content information is deleted after the timeout time has passed, such an incident that the content information of the moved content only is left can be prevented.

### Embodiment 3

Embodiment 3 according to the present invention will be described.

This Embodiment relates to the operations of the transmitter and receiver in the case where a portion of a content recorded in a transmitter for managing chapter information indicating a scene break in the content is copied to the receiver on the network. It should be noted that the present invention is not limited to the form shown in this Embodiment.

In this Embodiment, the configurations of the transmitter 110 and the receiver 130 are the same as those in FIGS. 2 and 3 described in Embodiment 1. Moreover, the sequence from searching of the transmitter 110 by the receiver 130 to the obtainment of the service information provided by the transmitter 110 is also the same as that in FIG. 7 described in Embodiment 1. The process sequence in the case where the receiver 130 copies a content which has chapter information from the transmitter 110 is the same as that in FIG. 8, but is different in that a copy range (start position and end position) is specified in a content copy request (S812). When a HTTP get request is used, it can be specified by using a Range header.

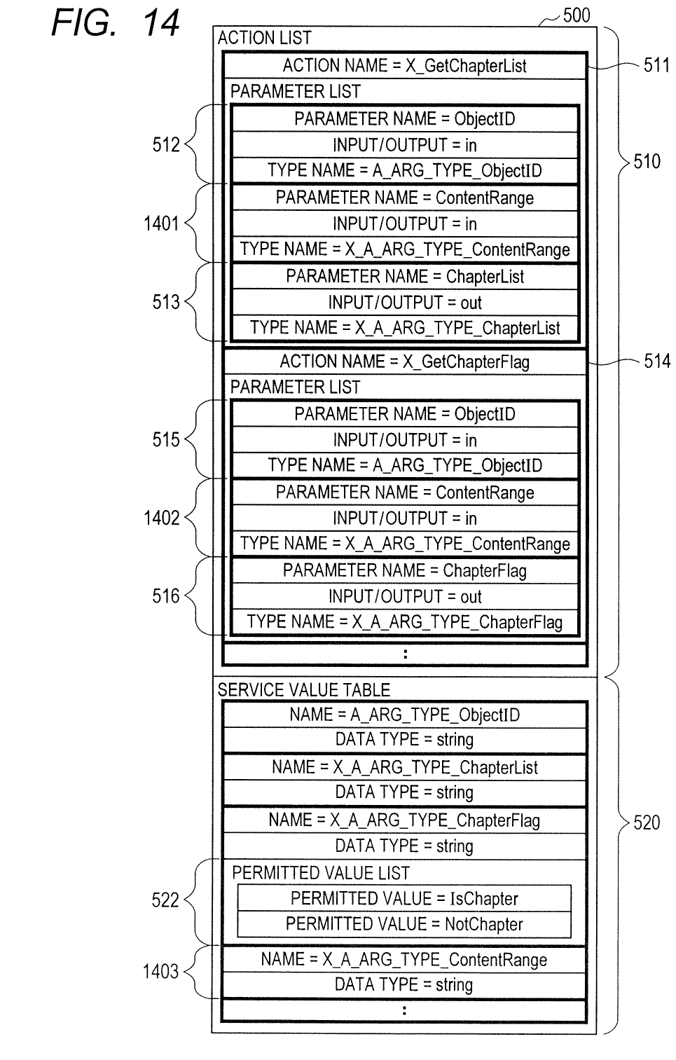

Moreover, in this Embodiment, as shown in FIG. 14, the specification of the content range is added to the parameters of the actions 511, 514 of the service description shown in FIG. 5A, and the chapter information with the specified range and the availability of the chapter information with the specified range are returned. Numerals 1401, 1402 in FIG. 14 are the definition of a parameter “ContentRange” for specifying the added content range. 1403 is the definition of the data type of a type name “X_A_ARG_TYPE_ContentRange” used in the parameter “ContentRange”. Like elements are denoted by like numerals in FIG. 14 and FIG. 5A, and their explanation is omitted.

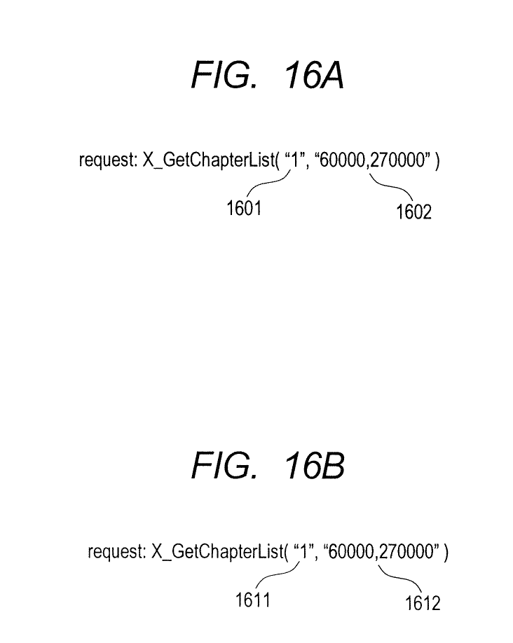

FIG. 16A is an example of an action “X_GetChapterList” request. 1601 is a first parameter “object ID”, while 1602 is the specification of a second parameter “ContentRange” which is additionally defined in this Embodiment. Both parameters are placed in double quotes (“) as they are of string type. A second parameter is divided by comma (,) to specify the start position and end positions of the content range. The action “X_GetChapterFlag” request is also specified in a similar format.

FIG. 16B is an example of the action “X_GetChapterFlag” request. As in FIG. 16A, 1611 is the first parameter “object ID”, while 1612 is the specification of a second parameter “ContentRange” which is additionally defined in this Embodiment.

The “X_GetChapterList” request in which the content range is specified, and the process of the transmitter 110 which has received the “X_GetChapterFlag” request will be descried below.

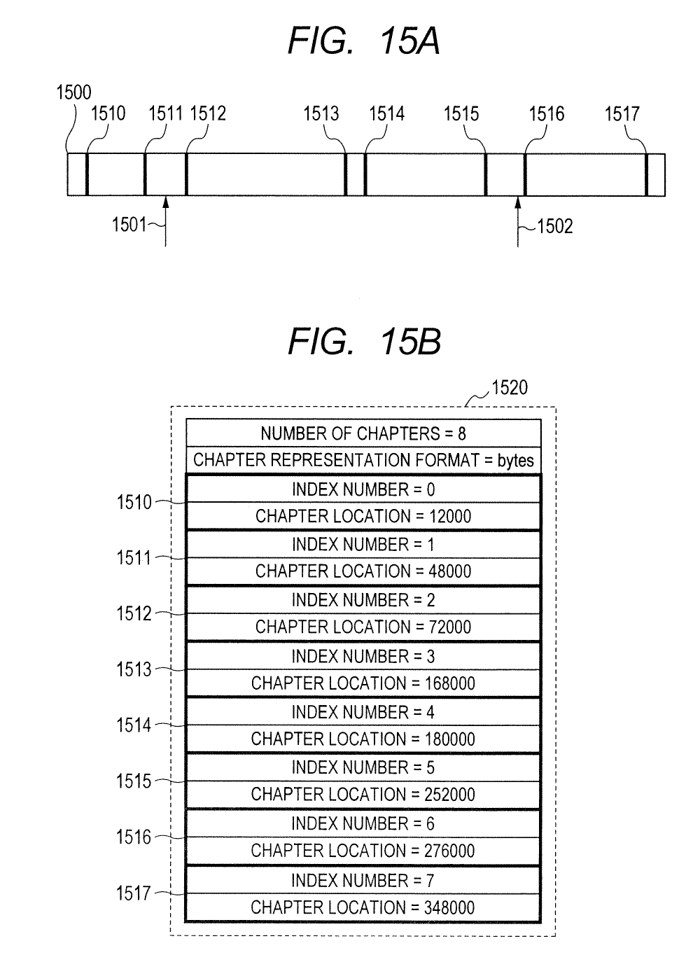

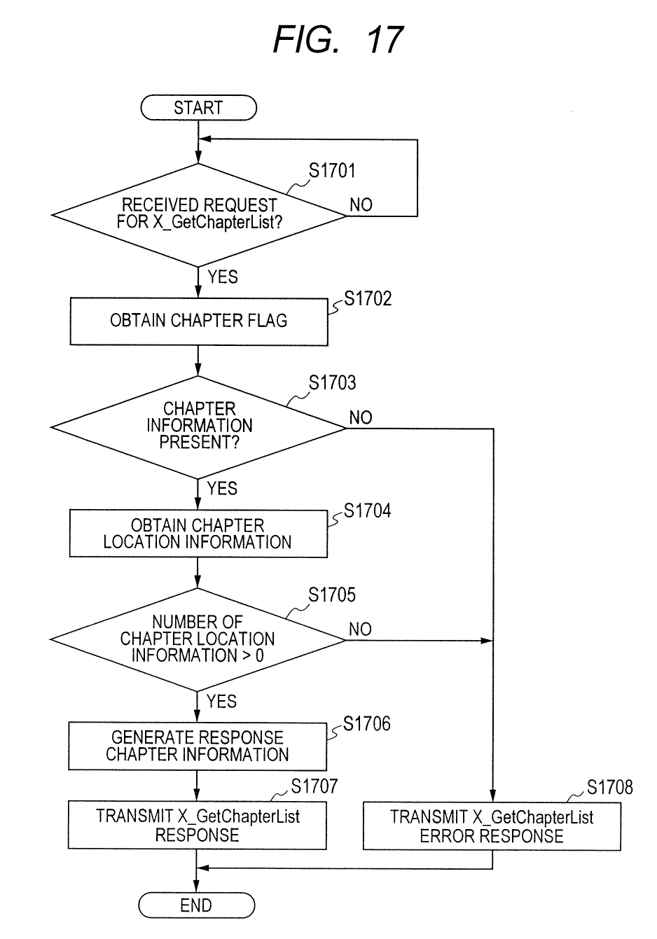

First, a process of receiving the “X_GetChapterList” request will be described with reference to FIGS. 17, 15A, 15B, 18A and 18B. FIG. 17 is a flow of the process of receiving the “X_GetChapterList” request including “ContentRange” in the control unit 220 of the transmitter 110; FIG. 15A schematically represents the chapter information indicating a scene break in a content stored in the transmitter 110; and FIG. 15B is chapter information 632 in FIG. 15A, which is managed as the chapter management information 630.

In FIG. 15A, a numeral 1500 represents a content stored in the transmitter, and numerals 1510, 1520, 1512, 1513, 1515, 1516, 1517 are chapters indicating scene breaks added to the content 1500. A numeral 1501 is a start position of the content specified by the parameter “ContentRange” of the “X_GetChapterList” request, and 1502 represents an end position. In the description below, it is assumed that the values specified in an example of the action “X_GetChapterList” request in FIG. 16A, start position=60000 and end position=270000 are specified.

FIG. 15B is a specific example of the chapter information of the content 1500. A numeral 1520 is the chapter information indicated by 632 in FIGS. 6 and 10. Numerals 1510 to 1517 are chapter position information of the chapters referred to by the same numerals in FIG. 15A. In FIG. 15A, the number of chapters is “8” as there are eight chapters. The chapter representation format is “bytes”, which represents the byte position from the top of the content in the case of FIG. 15B.

S1701: The control unit 220 starts a process when the chapter information processing unit 211 receives the action “X_GetChapterList” request. The chapter information processing unit 211 notifies the control unit 220 of the receipt of the action “X_GetChapterList” request, as well as of the parameters.

S1702: The control unit 220 refers to the network distributed content information 620 to check the presence or absence of the chapter information of the content specified by the parameter “object ID”, and obtains “content ID”. In addition, the chapter flag 612 of the content information in the recording medium 610 is obtained by “content ID”.

S1703: The control unit 220 judges the presence or absence of chapter information of the specified content by the value of the chapter flag 612. If the value of the chapter flag 612 is “IsChapter”, it is judged that the chapter information of the content is present, and the process proceeds to S1704. Otherwise, it is judged that the chapter information is absent, and the process proceeds to S1708 and an error response is returned.

S1704: When the chapter information of the specified content is present, the control unit 220 refers to the chapter management information 630, and obtains the chapter information position of the range specified by the parameter “ContentRange” of the action “X_GetChapterList” request. Herein it is assumed that the parameter “ContentRange” is set with start position=60000, end position=270000, as shown in FIG. 16A. The chapter information of the specified content is supposed to be FIG. 15B. The control unit 220 refers to the chapter position information that the chapter information 1520 has, and the chapter information with the value of the chapter position being not lower than the start position, but not higher than the end position are extracted. In the case of this Embodiment, with the values being not lower than 60,000 but not higher than 270,000, four pieces of chapter position information: 1512, 1513, 1514 and 1515, are extracted.

S1705: It is judged from the results of the process in S1704 whether or not the chapter information is contained in the specified content range. That is, it is judged that the chapter information is contained is larger than 0 if the number of the extracted pieces of chapter position information, and the process proceeds to S1706. If not, it is judged that the chapter information is not contained, and the process proceeds to S1708 and an error response is returned.

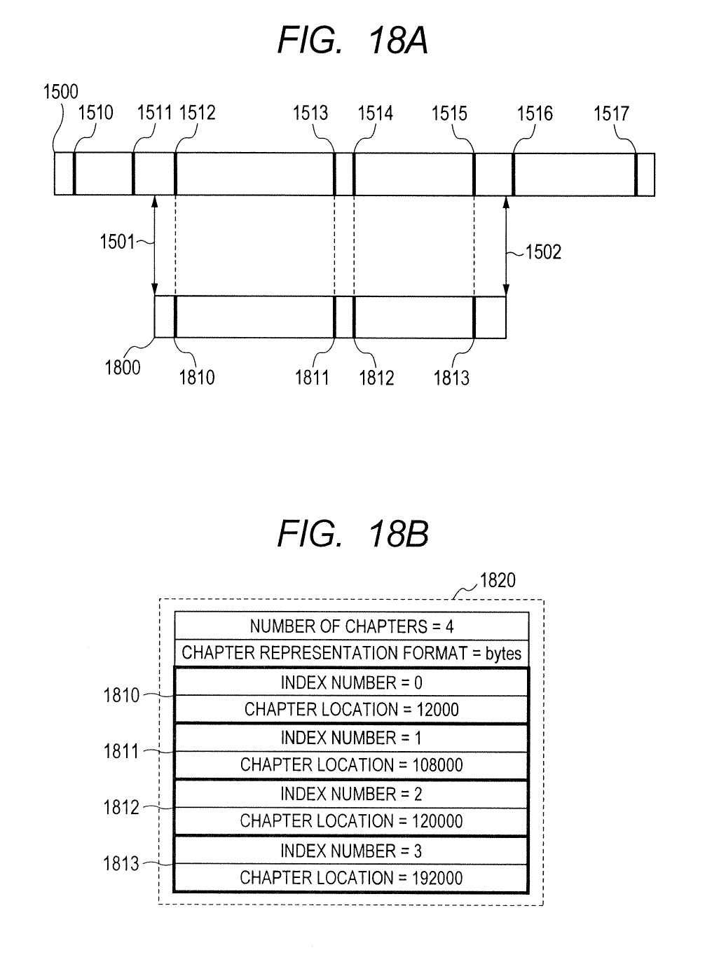

S1706: The control unit 220 generates “response chapter information” for response using the extracted chapter position information. The chapter information in FIG. 15B shows the chapter position from the top of the content, while the control unit 220 re-calculates the chapter position information with respect to the start position=60000 of the specified parameter “ContentRange”. Moreover, a value starting from 0 is assigned to an index number using the extracted chapter position information. FIG. 18A shows a schematic diagram of the chapter information indicating a content having a specified range and the scene break of the content, and FIG. 18B shows “response chapter information” generated by the control unit 220. In FIGS. 1A, 1B and FIG. 15, like elements are referred to by like numerals.

Numerals 1800 in FIG. 18A indicates the content whose range is specified by the parameter “ContentRange”, that is, numerals 1501, 1502. Numerals 1810, 1811, 1812 and 1813 are included in the content 1800 having the specified range in the chapters (1510 to 1517) indicating scene breaks added to the content 1500. The chapter 1512 of the content 1500 corresponds to the chapter 1810 of the content 1800. As shown in FIG. 18B, the control unit 220 assigns 0 to the index number of the chapter position information 1812 which is the top chapter in the content 1800, and assigns 1, 2 and 3 to numerals 1811, 1812 and 1813, respectively. The chapter position is re-calculated so that it indicates the position from the top of the content 1800. That is, with the value of the start position being 60000, the chapter position with the value of 72000 in numeral 1512 in FIG. 15B is 12000 in numeral 1810.

S1707: The chapter information processing unit 211 generates the “X_GetChapterList” response using “response chapter information” according to the direction of the control unit 220, and transmits the same.

S1708: The chapter information processing unit 211 generates an error response with an error code indicating that the content has no chapter information added according to the direction of the control unit 220, and transmits the same.

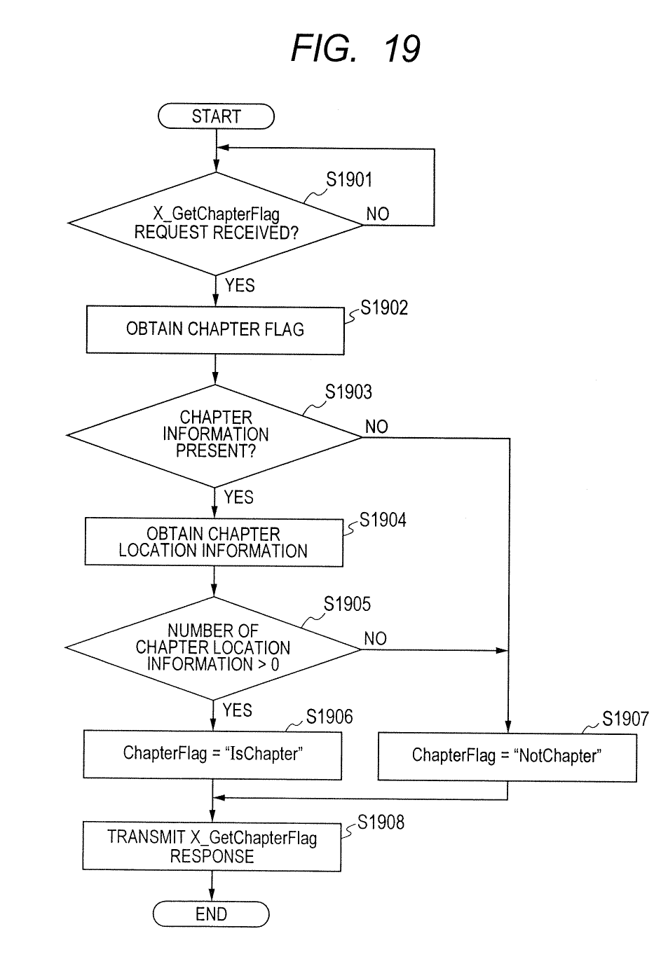

A process of receiving the “X_GetChapterFlag” request will be now described with reference to FIGS. 19, 15A and 15B. FIG. 19 is a flow of the process of receiving of the “X_GetChapterFlag” request in the control unit 220 of the transmitter 110.

S1901: The control unit 220 starts processing when the chapter information processing unit 211 receives the action “X_GetChapterFlag” request. The chapter information processing unit 211 notifies the control unit 220 of the receipt of the action “X_GetChapterFlag” request, as well as of the parameters.

S1902: The control unit 220 refers to the network distributed content information 620 to confirms the presence or absence of chapter information of the content specified by the parameter “object ID”, and obtains the content ID”. In addition, the control unit 220 obtains the chapter flag 612 of the content information in the recording medium 610 by the “content ID”.

S1903: The control unit 220 judges the presence or absence of chapter information of the specified content by the value of the chapter flag 612. It is judged that the chapter information of the content is present if the value of the chapter flag 612 is “IsChapter”, and the process proceeds to S1904. Otherwise, it is judged that the chapter information is absent, and the process proceeds to S1907.

S1904: When the chapter information of the specified content is present, the control unit 220 refers to the chapter management information 630, and obtains the chapter information position of the range specified by the parameter “ContentRange” of the action “X_GetChapterFlag” request. Herein, as shown in FIG. 16B, it is assumed that the parameter “ContentRange” is set with the start position=60000, and the end position=270000. Moreover, the chapter information of the specified content is assumed to be FIG. 15B. The control unit 220 refers to the chapter position information that the chapter information 1520 has, and the pieces of chapter information with their values of the chapter position being not lower than the start position, but not higher than the end position are extracted. In the case of this example, with the value being not lower than 60,000 but not higher than 270,000, four pieces of chapter position information, 1512, 1513, 1514, 1515, are extracted.

S1905: It is judged from the results of the process in S1904 whether or not the chapter information is contained in the specified content range. That is, it is judged that the chapter information is contained when the number of the extracted pieces of chapter position information is larger than 0, and the process proceeds to S1906. Otherwise, it is judged that the chapter information is not contained, and the process proceeds to S1907.

S1906: As the chapter information is contained in the specified content range, the control unit 220 sets the value of the output parameter 516 “ChapterFlag” to “IsChapter”.

S1907: As the chapter information is not contained in the specified content range, the control unit 220 sets the value of the output parameter 516 “ChapterFlag” to “NotChapter”.

S1908: The chapter information processing unit 211 generates the “X_GetChapterFlag” response using the output parameter “ChapterFlag” whose value has been set in S1906 or S1907 according to the direction of the control unit 220, and transmits the same.

As mentioned above, the parameter “ContentRange” is added to the action “X_GetChapterList” and action “ChapterFlag” in the transmitter 110 of this Embodiment. Accordingly, even when a portion of the content of a specified range is copied, the chapter information of the portion of the range can be provided. The receiver 130 is enabled to perform chapter skip and skip playback according to the chapter information when only a portion of the copied content is played, and the ease of use by the user can be thus improved.

### Embodiment 4

Embodiment 4 according to the present invention will be described.

This Embodiment relates to the operations of the transmitter and the receiver when a portion of a content recorded in a transmitter for managing chapter information indicating a scene break in the content is moved to a receiver on the network. It should be noted that the present invention is not limited to the form shown in this Embodiment.

In this Embodiment, the configurations of the transmitter 110 and the receiver 130 are the same as those in FIGS. 2 and 3 described in Embodiment 1. Moreover, the sequence from searching of the transmitter 110 by the receiver 130 to the obtainment of the service information provided by the transmitter 110 is also the same as that in FIG. 7 described in Embodiment 1. A process sequence in the case where a content having chapter information is moved from the transmitter 110 by the receiver 130 is a sequence in which S812 is replaced with a content move request, and S813 is replaced with a move content transmission, and a range to be moved (start position and end position) (S812) is specified in the content move request. The range can be specified by using a Range header when the HTTP get request is used.

In this Embodiment, the transmitter 110 manages content management information for both the moved portion and unmoved portion of the content after the move content, which is a portion of the content, is transmitted (completed).

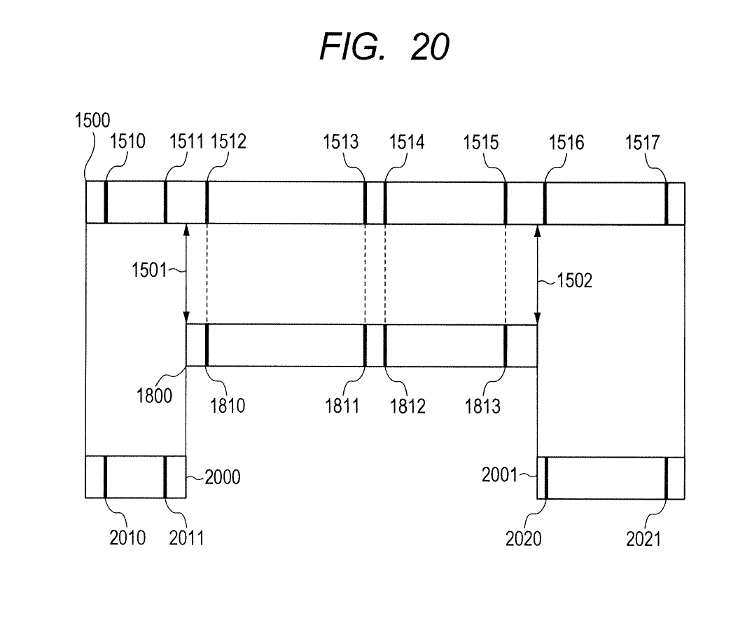

Herein, the case where the content ranging from the start position=60000 and the end position=270000 is moved will be described as an example. FIG. 20 is a drawing which schematically shows a stored content and chapter information indicating a scene break in the content. In the figure, the same elements as those in FIG. 15 referred to by the same numerals. A numeral 1800 indicates the moved content by a request to move a portion of the content. A numeral 1501 indicates a start position, while A numeral 1502 indicates an end position. Numerals 1810, 1011, 1812 and 1813 are chapters contained in the moved content 1800 among the chapters (1510 to 1517) indicating scene breaks added to the content 1500. Numerals 2000 and 2001 are the content left after the portion of the content 1800 has been moved. In addition, numerals 2010 and 2011 are chapters contained in the content 2000, while numerals 2020 and 2021 are chapters contained in the content 2001.

The control unit 220 of the transmitter 110 generates the content management information of the content divided into three portions, contents 1800, 2000 and 2001, after the move content, which is a portion of the content, is moved (completed), and retains the information via the content information controlling unit 205.

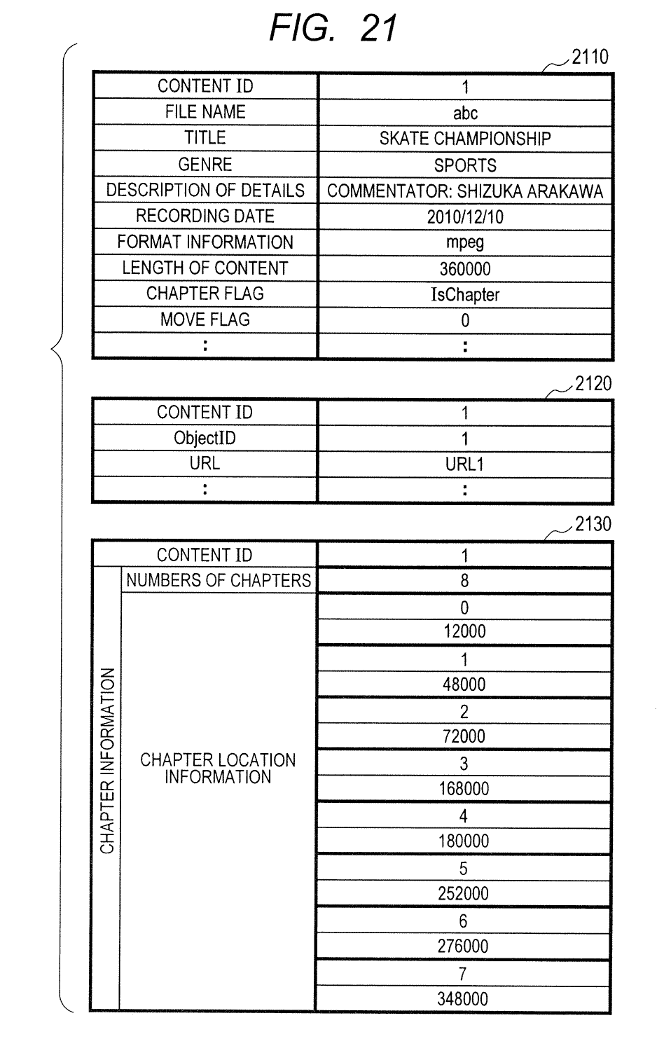

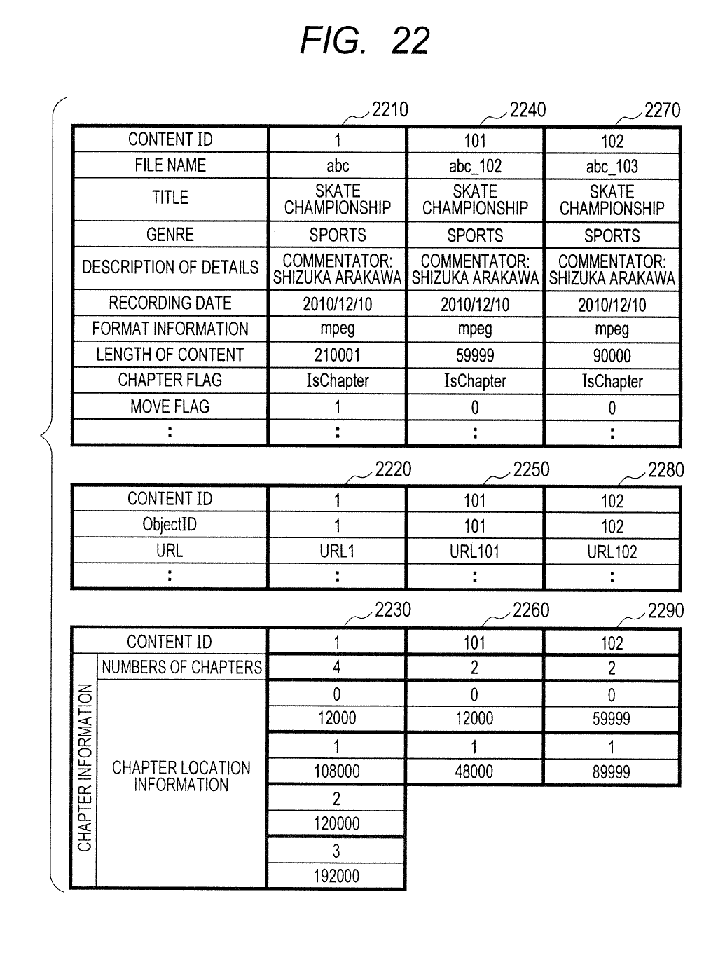

The content information management process after the move content, which is a portion of the content, has been transmitted (completed) will be described with reference to FIGS. 21 and 22.

FIG. 22 is a specific example of content management information, content information in the recording medium 2110, distributed content information 2120, and chapter management information 2130 for managing the content 1500. Herein, the content ID of the content 1500 is set to “1”, and the object ID is also set to “1”. In the chapter management information 2130, as described in FIG. 10, the chapter position information of each chapter includes two pieces of information: an index number and a chapter position. In the figure, the upper row indicates the index number, while the lower row indicates the chapter position. The chapter position information of the index number “0” of 2130 corresponds to the chapter 1510 in FIG. 20. Likewise, the index numbers “1” to “7” corresponds to the chapters 1511 to 1517, respectively, in FIG. 20.

Herein, when the content transmission of a portion (start position=60000, end position=270000) of the content is completed by the move request, the transmitter 110 reconstructs the content management information in the content information controlling unit 205 as shown in FIG. 22. A content information in the recording medium 2210, distributed content information 2200, and chapter management information 2230 are the moved portions, that is, the content management information of the content 1800 (FIG. 20). The content information in the recording medium 2240, distributed content information 2250 and chapter management information 2260 are the content management information of the content 2000 (FIG. 20). The content information in the recording medium 2270, distributed content information 2280 and chapter management information 2290 are the content management information of the content 2001 (FIG. 20).

The control unit 220 of the transmitter 110 uses the content ID and Object ID assigned to the content 1500 as those for the content 1800 of the moved portion as they are, considering obtaining the chapter information from the receiver which has requested the content. The content 2000 and content 2001 are generated and managed using the content management information (FIG. 21) of the content 1800, with new content ID and object ID assigned thereto. Herein, content ID=101 and object ID=101 are assigned to the content 2000, while content ID=102 and object ID=102 are assigned to the content 2001. Moreover, new file name and URL for saving the content are also assigned. A content length is calculated from the content length=360,000 (FIG. 22) of the original content 1500 and the content range (start position=60000, end position=270000) of and the request to move a portion of the content.

The chapter flag is determined from the chapter position information and the range of the content of the chapter management information 2130 in FIG. 21, by a method similar to the procedure shown in FIG. 19 of Embodiment 3. Since the range of the content 1800 of which a portion is moved is from the start position=60000 to the end position=270000, the range of the content 2000 is from the start position=0 to the end position=59999. The range of the content 2001 is from the start position=270001 to the end position=360000. In the case of this example, all of the contents 1800, 2000 and 2001 have the chapter position information, and therefore “IsChapter” is set in the chapter flags of the contents.

The chapter information is also determined from the chapter position information and the range of the content at the chapter management information 2130 in FIG. 21 by a method similar to the procedure shown in FIG. 17 of Embodiment 3. The value of the chapter position is calculated based on the start position of each content. The MOVE flag is the content 1800 which has been moved. Therefore, only the MOVE flag of the recording medium 2210 is set to “1”. The content management information 2210, 2220, 2230 of the value “1” of the MOVE flag are deleted when a predetermined time has passed since the content was moved, or when an action “X_GetChapterList” request which is a chapter information request is received from the receiver which has requested to move the content and the process is finished.

As mentioned above, when the transmitter 110 of this Embodiment receives the request to move a portion of the content, it generates the content management information, content information in the recording medium, distributed content information and chapter management information for each of the moved portion and the unmoved portion. Therefore, the chapter information of the portion of the content moved can be provided to the receiver which has obtained the portion. In addition, the chapter information of the rest of the content can be also retained.

### Embodiment 5

This Embodiment relates to the operations of the transmitter and the receiver when a content recorded in a transmitter for managing chapter information indicating a scene break in the content is copied to a receiver on a network. It should be noted that the present invention is not limited to the form shown in this Embodiment.

In this Embodiment, the configurations of the transmitter 110 and the receiver 130 are the same as those in FIGS. 2 and 3 described in Embodiment 1. Moreover, the sequence from searching of the transmitter 110 by the receiver 130 to the obtainment of the service information provided by the transmitter 110 is also the same as that in FIG. 7 described in Embodiment 1.

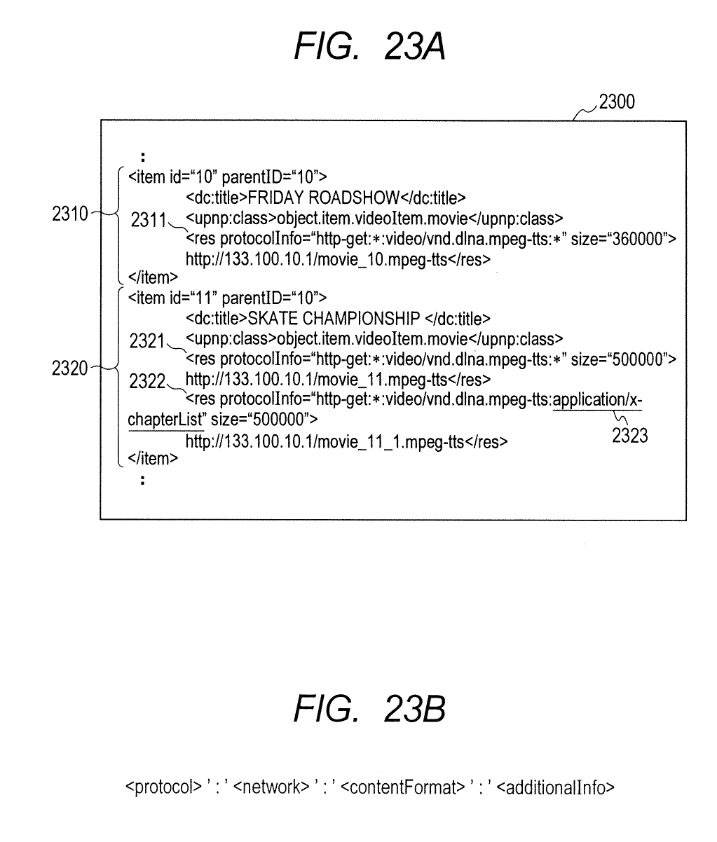

The difference between this Embodiment and Embodiment 1 is that a URL for providing the content and chapter information for a content of which the chapter information is available is included in the content list response, in addition to the URL 623 providing the content (hereinafter referred to as chapter content URL). FIG. 23A shows an example of the content list response. FIG. 23A shows the case where the content list response is indicated in the XML format. Moreover, FIG. 23A indicates only the portions of the respective content information, and does not include the header portions and the like of the HTTP response. In FIG. 23A, the portions 2310, 2320 surrounded by <item> tags are each the content information of a single content. The content information of each content includes that shown in FIG. 11. In this example, a title <dc:title> and the type of the content <upnp:class> are shown as examples. In addition, a <res> tag is a tag indicating the URL which provides the content. The content 2310 is for the case where only the URL of the content is contained, while 2311 is a <res> tag which provides the URL of the content. The content 2320 contains two <res> tags, 2321 and 2322.

A numeral 2321 is a URL which provides the content, while a numeral 2322 is a chapter content URL for providing the content and chapter information. Whether the URL provided by the <res> tag is the URL which provides the content or the chapter content URL is identified by the property information of the <res> tag. In this Embodiment, it is identified by the field information of a procolInfo property given to the <res> tag. FIG. 23B is an example of the definition of the field which the protocolInfo property has. As shown in FIG. 23B, the protocolInfo property has four fields. A first field <protocol> indicates the protocol when the content is output. FIG. 23A shows that the content is output by HTTP GET. A second field <network> is a field which depends on the output protocol, and the symbol “*” (asterisk) is described in the case of HTTP. A third field <contentFormat> indicates the format of the content. A fourth field <additonalInfo> is a field indicating additional information. In this example, whether it is the URL which provides the content or the chapter content URL is indicated by using this <additonalInfo>. As shown at a numeral 2323 in FIG. 23A, when “application/x-chapterList” is described in the fourth field, it indicates that it is the chapter content URL.

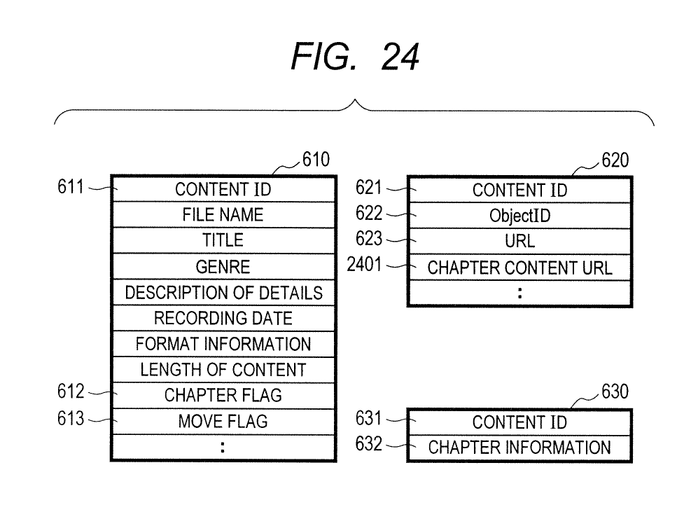

The control unit 220 of the transmitter 110 generates the chapter content URL for providing the chapter information and the content when the chapter information of the content is generated by the chapter information generating unit 209, and stores the URL in the distributed content information via the content information controlling unit 205. FIG. 24 shows the configuration of the content management information, content information in the recording medium, chapter management information and distributed content information managed by the content information controlling unit 205 of the transmitter 110. The same elements as in FIG. 6 are referred to by the same numerals. And their explanation is omitted. A numeral 2401 is a URL for providing the content and the chapter information added to the content.

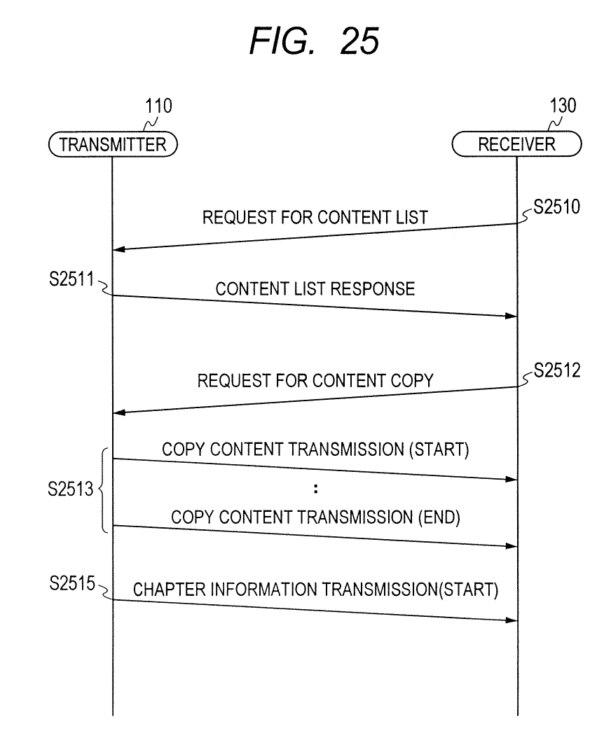

FIG. 25 shows a process sequence of providing a content list and providing a content according to the present invention.

S2510: First, the receiver 130 obtains content list information recorded in the transmitter 110 to determine a content to copy. The content list information can be obtained using a Browse action of the “ContentDirectory” service. The control unit 320 of the receiver 130 controls the content information processing unit 312, and has a “browse request” message issued to the control URL “by using a HTTP POST request and the like.

S2511: The control unit 220 of the transmitter 110 which has received the “Browse request” message issued for the control URL controls the content information processing unit 212, and has a “Browse response” message transmitted by using a HTTP response message. The content information processing unit 212 refers to the content information in the recording medium 610 and distributed content information 620 previously described in FIG. 24, and generates content information for Browse response for each content. The content information for Browse response when indicated in the XML format is as shown in FIG. 23A. As described in FIG. 23A, it is indicated that it is the URL for providing the content and the chapter information added to the content by describing “application/x-chapterList” in the fourth field of the protocolInfo property of the <res> tag.

The control unit 320 of the receiver 130 which has received a response “browse response” message from the transmitter 110 can obtain the content information of each content from the content information for Browse response 1100 obtained, analyzed and processed in the content information processing unit 312 (title, genre, URL, chapter content URL, etc.). The control unit 320 prompts the user to select a content to copy by displaying information such as the title, recording date and time of the content on the display unit 304 and presenting the same to the user, or by other means. At this time, it is presented that the chapter information is available by icons, characters and the like to have the user decide whether or not to copy the chapter information together with the content. When a content to copy is selected, the control unit 320 gives the content information of the selected content to the content information controlling unit 305, has it generate the content information as shown in FIG. 6, and has it store the content information. In the information of the content information in the recording medium 610, the content ID 611 and file name are generated by the content information controlling unit 305. The content ID 611 assigns an ID for uniquely specifying the content recorded in the recording medium of the receiver 130, as well as the file name. The value of the chapter flag 612 is set after the chapter information is obtained. Other information (title, genre, detailed description, recording date and time, format information, etc.) sets the obtained content information for the Browse response. The receiver 130, which does not have distributed content information 620, manages the received content information 650 having the same data configuration. The received content information 650 is the information for retaining an object ID 622 which is the content identification information of the transmitter 110 and an URL 623 which is the URL information of the source of the content, and for reference of association with the content ID assigned by the content information controlling unit 305. The content information managing unit 305 retains the received content information 650 until a series of processes of copying the content is completed.

S2512: The receiver 130 transmits a “content copy request” to the URL obtained from the content information for Browse response by using the HTTP get request and the like. In this example, the case where a request is transmitted to the chapter content URL which provides the content and the chapter information added to the content will be described.

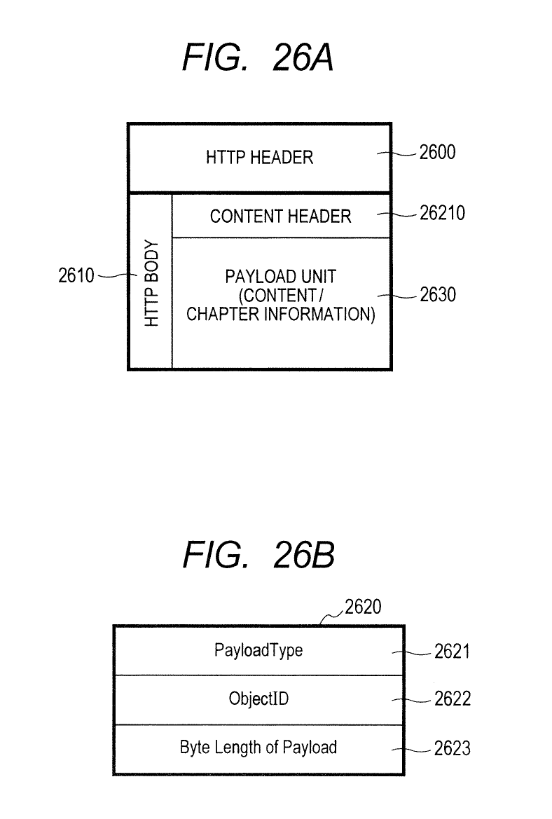

S2513: The control unit 220 of the transmitter 110 transmits the content specified by the URL via the content transmitter 207. When the chapter content URL is specified, the content is transmitted first, and then the chapter information is transmitted (described later in S2515). Whether to transmit the content or the chapter information is distinguished by a header. FIG. 26A shows the format when the content and chapter information are transmitted by using the HTTP protocol. A numeral 2600 is a HTTP header, while a numeral 2610 is a HTTP body into which a HTTP message is inserted. In the case of this example, a content header 2620 and a payload portion 2630 are inserted into the HTTP body 2610. The payload portion 2630 is a portion into which the content and chapter information are inserted. The content header 2620 includes, as shown in FIG. 26B, PayLoadType 2621, Object ID 2622, and Byte Length of Payload 2623. The content header 2620 is the information for the PayLoadType 2621 to identify whether the content of the payload portion 2630 is content data or chapter information. When the content is transmitted, the PayLoadType 2621 is transmitted with the value “0” indicating transmission of the content. The object ID 2622 is the object ID of the transmitted content. The Byte Length of Payload 2621 indicates the number of bytes of the payload portion 2630.

The receiver 130 receives the content in the content receiving unit 307, judges that it is the receipt of the content from the PayLoadType 2621 of the content header 2620, and records the content in the recording medium 306 by the file name assigned by the content information controlling unit 305 in S811. When the receiving of the content is complete, the content information controlling unit 305 updates and records the content information in the recording medium 610 with an actually received content length, and records the information in the recording medium 306.

S2515: When the transmitter 110 finishes transmitting the content, it transmits the chapter information successively. At this time, the transmitter 110 transmits the PayLoadType 2621 of the content header 2620 with the value “1” indicating the transmission of the chapter information. The receiver 130 receives the content in the content receiving unit 307, judges that it is the receipt of the chapter information from the PayLoadType 2621 of the content header 2620, and stores the obtained content information in the chapter information 632 of the chapter management information 630 of the content received in S2513.

As mentioned above, the receiver can obtain the content and the chapter information together by providing a URL (chapter content URL) for providing the content and the chapter information associated with the content which can provide the chapter information in addition to URL for providing the content as the content list response. Therefore, processing on the receiver side is simplified and more easily implemented.

In this Embodiment, the content list response includes the content and the chapter information associated with the content which can provide the chapter information for providing the URL in addition to the URL for providing the content 623, but the equipment information disclosed to devices on the network may be obtained by the transmitter by the receiver so that the content and the URL for providing the chapter information is contained in the content list response and provided when the chapter information is available for the receiver. Accordingly, the transmitter realizes compatibility with conventional devices since it sends the content list response in a conventional format which does not contain the URL for providing the content and the chapter information to a receiver for which the chapter information is not available. Moreover, since the content list response in a conventional format is sent to a receiver for which the chapter information is not available, a load of processing the content list response is reduced.

In this Embodiment, as already described in connection with the case of the content copy request, the processing sequence of moving the content is also the same. In the case of moving the content, the transmitter 110 after the transmission process in S2515 is completed, the information of the transmitted content, i.e., the content information in the recording medium 610, network distributed content information 620 and chapter management information 630, are deleted. The content is moved when a request to move the content is received by the chapter content URL. Therefore, no such incident that no chapter information get request is sent from the receiver and only the chapter information is left occurs, and thus the processing on the transmitter side is also simplified and facilitated.

What is claimed is:

1. A transmitter comprising a content transmitter which transmits a content via a network, the transmitter having:
a chapter information processing unit which retains chapter information indicating a scene break in the content, and transmits the retained chapter information via the network, and
an equipment information processing unit which transmits the chapter information to a different device connected to the network via the network, and
the transmitter transmitting a content and chapter information according to a request of the different device.

2. The transmitter according to claim 1, wherein
when a portion of the content is specified by a start position and an end position in the request, the chapter information processing unit generates the chapter information for the content specified by the start position and the end position from the retained chapter information in the content of which chapter information is requested, and transmits the chapter information.

3. The transmitter according to claim 1, wherein
the transmitter further comprises a content information processing unit which stores content information having at least a URL indicating a title and a source of the content of the retained content in a recording medium, and provides the content information in response to a request, and
when chapter information corresponding to the content specified by a request of the different device in the retained content is stored in the recording medium, a URL for providing chapter information corresponding to the URL and the content for providing the specified content is provided as the content information.

4. A transmission method comprising a content transmitting step for transmitting a content via a network, the method having:
a chapter information processing step for retaining chapter information indicating a scene break in the content, and transmitting the retained chapter information via the network, and
an equipment information processing step for transmitting the chapter information to a different device connected to the network via the network, the method comprising:
transmitting a content and chapter information according to a request of the different device.
